(19) United States
(12) Patent Application Publication
(10) Pub. No.: US 2026/0369665 A1
(43) Pub. Date: Nov. 19, 2026

(54) GREEN BODY AND METHODS OF FORMING THE SAME

(71) Applicant: ION STORAGE SYSTEMS, INC., Beltsville, MD (US)

(72) Inventors: Dennis Mcowen, Beltsville, MD (US); Patrick Stanley, Beltsville, MD (US); Derek Seymour, Beltsville, MD (US)

(21) Appl. No.: 19/130,395

(22) PCT Filed: Nov. 16, 2023
(86) PCT No.: PCT/US2023/080034

§ 371 Date: May 15, 2025

Related U.S. Application Data
(60) Provisional application No. 63/384,123, filed on Nov. 17, 2022.

(51) Int. Cl. H01M 10/0562; C04B 35/488; C04B 35/634

(52) U.S. Cl. CPC H01M 10/0562; C04B 35/488; C04B 35/634; C04B 2235/3203; C04B 2235/3227; C04B 2235/3244; C04B 2235/48; C04B 2235/5436; C04B 2235/608; H01M 2300/0077

(57) ABSTRACT

In one aspect, the present invention provides a green body for forming a solid-state electrolyte (SSE). The green body comprises a LLZO material and a binder. Another aspect provides a method of forming a green body for a SSE.

### CROSS-REFERENCE TO RELATED APPLICATION

This application claims the benefit of U.S. Provisional Application No. 63/384,123, filed on Nov. 17, 2022, which is hereby incorporated by reference in its entirety.

### GOVERNMENT LICENSE RIGHTS

This invention was made with government support under contract no. SP4701-20-F-0115 awarded by the Defense Logistics Agency. The U.S. government has certain rights in the invention.

### FIELD OF THE INVENTION

The present invention provides a green body for forming a solid-state electrolyte and methods of forming the same.

### BACKGROUND

Solid-state batteries may include a dense, solid-state electrolyte (SSE) separator layer comprising a lithium lanthanum zirconium oxide (LLZO) material. The SSE separator layer prevents electronic conduction and allows ionic conduction between an anode and a cathode. The SSE separator layer should have a sufficiently low porosity such that a relative density of the SSE separator layer is near the theoretical density for the SSE separator layer. This ensures that there are no open pathways for anolyte and/or catholyte seepage or lithium dendrite formation or propagation.

The SSE separator layer is formed from a green body. The green body is used as an intermediary to take loose LLZO powder and form the desired macroscopic structure, in addition to microscopically positioning the LLZO powder so that it can fully densify during sintering. The SSE material in the green body is formed by first reacting (e.g., calcining) multiple precursor powders followed by additional processing steps. The prepared LLZO powder is then formed into a green body by a process that combines the powder with a binder (e.g., a polymer binder). Standard industry processes for green body formation (e.g., tapecasting), typically require one or more solvents or other additives. However, for reactive materials like LLZO, the solvents or additives used in green body formation have been found to react with the LLZO material to form phase impurities. For LLZO materials, one of the major phase impurities is a protonated form of LLZO (i.e., LiHLZO) that has a substantially lower density.

The formed green body undergoes a debinding process wherein a binder and other organic components are substantially removed from the green body. The green body further undergoes a sintering process, wherein pore elimination and grain growth occur. Accordingly, the green body necessarily reduces in size (i.e., shrinks) as a result of pore elimination during sintering. Phase changes may also occur during sintering, due to underlying impurities (e.g., phase impurities) in the green body, which may substantially change the density.

A green body that exhibits minimal shrinkage when sintered is desirable. Specifically, a reduction in shrinkage results in greater control and predictability over the sintered products (e.g., SSE separator layers, bilayers, etc.), including the uniformity and dimensions of such products. A reduction in shrinkage may also allow for greater production efficiency, since more green bodies may be loaded into the sintering apparatus (e.g., furnace) at any one time. Shrinkage is directly impacted by changes in density. Phase impurities formed during green body formation that impact the density can therefore also impact the amount of shrinkage observed during debinding and sintering. Formation of LiHLZO, and other impurities, during green body formation lowers the density of the LLZO powder and the density of the green body. Upon debinding and sintering, the decomposition of LiHLZO causes an increase in density and, therefore, a greater degree of areal and volumetric shrinkage. A SSE green body without phase impurities would minimize density changes and shrinkage upon debinding and sintering, and enable greater process control and efficiency.

As such, there remains need to provide an improved SSE green body for reactive materials such as LLZO.

### SUMMARY OF THE INVENTION

In one aspect, the present invention provides a green body for forming a solid-state electrolyte (SSE).

In another aspect, the present invention provides a green body for forming a solid-state electrolyte (SSE). The green body comprises a LLZO material and a binder. The green body has a percent density of at least about 87.5%. In some embodiments, the green body has a percent density of at least about 90%. In other embodiments, the green body has a percent density of at least about 92.5%. In some embodiments, the green body has a percent density of at least about 95%. And, in some embodiments, the green body has a percent density of at least about 97.5%. In some embodiments, the green body (e.g., the cured SSE green body) has a percent density of from about 88.5% to about 99.99% (e.g., from about 89% to about 99%).

In some embodiments, the LLZO material comprises a LLZO powder, a doped LLZO powder, or any combination thereof. In other embodiments, the LLZO material comprises a LLZO powder. And, in some embodiments, the LLZO material comprises a doped LLZO powder. In other embodiments, the LLZO material is calcined.

In some embodiments, the doped LLZO powder comprises a dopant comprising Be, B, Al, Fe, Zn, Ga, Ge, Na, K, Ca, Rb, Sr, Y, Ag, Ba, Bi, Pr, Nd, Pm, Sm, Gd, Tb, Dy, Ho, Er, Tm, Ce, Mg, Si, Sc, Ti, V, Cr, Mn, Co, Ni, Cu, As, Se, Nb, Mo, Tc, Ru, Rh, Pd, Cd, In, Sn, Sb, Hf, Ta, W, Ir, Pt, Au, Hg, Tl, Pb, Eu, Te, or any combination thereof.

In some embodiments, the doped LLZO powder comprises a composition of Formula (I):

M1₇₋ₓD1ₐM2_{3-y}D2_{b}M3_{2-z}D3_{c}O_{12-w}D4_{d} (I)

wherein
M1 is Li;
M2 is La;
M3 is Zr;
D1 is Be, B, Al, Fe, Zn, Ga, Ge, or any combination thereof;
D2 is Na, K, Ca, Rb, Sr, Y, Ag, Ba, Bi, Pr, Nd, Pm, Sm, Gd, Tb, Dy, Ho, Er, Tm, Zn, Ce, or any combination thereof;
D3 is Mg, Si, Sc, Ti, V, Cr, Mn, Co, Ni, Cu, Ge, As, Se, Nb, Mo, Tc, Ru, Rh, Pd, Cd, In, Sn, Sb, Hf, Ta, W, Ir, Pt, Au, Hg, Tl, Pb, Ce, Eu, Te, Y, Sr, Ca, Ba, Gd, Ge, or any combination thereof; and
D4 is F, Cl, Br, I, S, Se, Te, N, P, or any combination thereof;
   provided that
0≤w≤2;
−0.5<x≤3;
0≤y≤3;
0≤z≤2;
0≤a≤2;
0≤b≤3;
0≤c≤2; and
0≤d≤2;
   wherein at least one of a, b, c, and d is >0.

In some embodiments, the LLZO material has a D90 particle size of less than about 10 μm. In other embodiments, the LLZO material has a D90 particle size of less than about 5 μm. And, in some embodiments, the LLZO material has a D90 particle size of less than about 2.5 μm.

In some embodiments, the binder is cured by exposure to ultraviolet (UV) radiation. In other embodiments, the cured binder comprises a cross-linked polymer material.

In some embodiments, the green body has a thickness of from about 500 nm to about 100 μm. In some embodiments, the green body has a thickness of from about 1 μm to about 100 μm. In other embodiments, the green body has a thickness of from about 1 μm to about 75 μm. In some embodiments, the green body has a thickness of from about 1 μm to about 50 μm. In some embodiments, the green body has a thickness of from about 1 μm to about 25 μm. In other embodiments, the green body has a thickness of from about 1 μm to about 80 μm. In some embodiments, the green body has a thickness of from about 20 μm to about 80 μm. And, in some embodiments, the green body has a thickness of from about 20 μm to about 60 μm.

In some embodiments, the green body further comprises a first layer and a second layer at least partially disposed on the first layer. In such embodiments, the LLZO material is further defined as a first LLZO material and the binder is further defined as a first binder. The first layer comprises the first LLZO material and the first binder. The second layer comprises a second LLZO material and a second binder.

In some embodiments, the second layer further comprises a pore forming agent. In other embodiments, the first layer is substantially free of a pore forming agent.

In some embodiments, the first layer has a thickness of from about 500 nm to about 100 μm. In some embodiments, the first layer has a thickness of from about 1 μm to about 100 μm. In other embodiments, the first layer has a thickness of from about 1 μm to about 75 μm. In some embodiments, the first layer has a thickness of from about 1 μm to about 50 μm. And, in some embodiments, the first layer has a thickness of from about 1 μm to about 25 μm.

In some embodiments, the second layer has a thickness of from about 500 nm to about 100 μm. In some embodiments, the second layer has a thickness of from about 1 μm to about 100 μm. In other embodiments, the second layer has a thickness of from about 1 μm to about 80 μm. In some embodiments, the second layer has a thickness of from about 20 μm to about 80 μm. And, in some embodiments, the second layer has a thickness of from about 20 μm to about 60 μm.

One aspect of the present invention provides a sintered SSE material comprising (i) less than about 10 wt % of LiHLZO by weight of the SSE material; and (ii) greater than 90 wt % by weight of the SSE material of a doped LLZO material of Formula (V)

Li₇₋ₓBa La_{3-y}C_{b}Zr_{2-z}D_{c}O₁₂ (V),

wherein:
B is Al or Ga;
C is Ca, Sr, Ba, or Mg;
D is Ta, Nb, W, Mo, or Ti;
−0.5<x≤1;
0<a<0.24;
0<y≤0.5;
0<b≤0.5;
0<z≤1; and
0<c≤1;
   where x, a, y, b, z, and c are independent of each other.

In some embodiments, 0.2≤x≤0.8; 0<a≤0.15; 0<y≤0.3; 0<b≤0.3; 0<z≤1; and 0<c≤1.

In some embodiments, x is 0.15 to 0.7.

In some embodiments, B is Al, and a is 0.05 to 0.15. For example, x is 0.15 to 0.7, B is Al, and a is 0.05 to 0.15.

In some embodiments, B is Ga, and a is 0.05 to 0.8. For example, x is 0.15 to 0.7, B is Ga, and a is 0.05 to 0.8.

In some embodiments, y is 0.05 to 0.30. For example, x is 0.15 to 0.7, B is Al, a is 0.05 to 0.15, and y is 0.05 to 0.30. In other examples, x is 0.15 to 0.7, B is Ga, a is 0.05 to 0.8, and y is 0.05 to 0.30.

In some embodiments, C is Ca, and b is 0.05 to 0.25. For example, x is 0.15 to 0.7, B is Al, a is 0.05 to 0.15, y is 0.05 to 0.30, C is Ca, and b is 0.05 to 0.25. In other examples, x is 0.15 to 0.7, B is Ga, a is 0.05 to 0.8, y is 0.05 to 0.30, C is Ca, and b is 0.05 to 0.25.

In some embodiments, C is Ba, and b is 0.05 to 0.10. For example, x is 0.15 to 0.7, B is Al, a is 0.05 to 0.15, y is 0.05 to 0.30, C is Ba, and b is 0.05 to 0.10. In other examples, x is 0.15 to 0.7, B is Ga, a is 0.05 to 0.8, y is 0.05 to 0.30, C is Ba, and b is 0.05 to 0.10.

In some embodiments, C is Sr, and b is 0.25 to 0.30. For example, x is 0.15 to 0.7, B is Al, a is 0.05 to 0.15, y is 0.05 to 0.30, C is Sr, and b is 0.25 to 0.30. In other examples, x is 0.15 to 0.7, B is Ga, a is 0.05 to 0.8, y is 0.05 to 0.30, C is Sr, and b is 0.25 to 0.30.

In some embodiments, C is Mg, and b is 0.22 to 0.28. For example, x is 0.15 to 0.7, B is Al, a is 0.05 to 0.15, y is 0.05 to 0.30, C is Mg, and b is 0.22 to 0.28. In other examples, x is 0.15 to 0.7, B is Ga, a is 0.05 to 0.8, y is 0.05 to 0.30, C is Mg, and b is 0.22 to 0.28.

In some embodiments, z is 0.50 to 1. For example, x is 0.15 to 0.7, B is Al, a is 0.05 to 0.15, y is 0.05 to 0.30, C is Ca, b is 0.05 to 0.25, and z is 0.50 to 1. In some examples, x is 0.15 to 0.7, B is Ga, a is 0.05 to 0.8, y is 0.05 to 0.30, C is Ca, b is 0.05 to 0.25, and z is 0.50 to 1. In some examples, x is 0.15 to 0.7, B is Al, a is 0.05 to 0.15, y is 0.05 to 0.30, C is Ba, b is 0.05 to 0.10, and z is 0.50 to 1. In some examples, x is 0.15 to 0.7, B is Ga, a is 0.05 to 0.8, y is 0.05 to 0.30, C is Ba, b is 0.05 to 0.10, and z is 0.50 to 1. In some examples, x is 0.15 to 0.7, B is Al, a is 0.05 to 0.15, y is 0.05 to 0.30, C is Sr, b is 0.25 to 0.30, and z is 0.50 to 1. In some examples, x is 0.15 to 0.7, B is Ga, a is 0.05 to 0.8, y is 0.05 to 0.30, C is Sr, b is 0.25 to 0.30, and z is 0.50 to 1. In some examples, x is 0.15 to 0.7, B is Al, a is 0.05 to 0.15, y is 0.05 to 0.30, C is Mg, b is 0.22 to 0.28, and z is 0.50 to 1. And, in some examples, x is 0.15 to 0.7, B is Ga, a is 0.05 to 0.8, y is 0.05 to 0.30, C is Mg, b is 0.22 to 0.28, and z is 0.50 to 1.

In some embodiments, D is Ta, and c is 0.4 to 0.6. For example, x is 0.15 to 0.7, B is Al, a is 0.05 to 0.15, y is 0.05 to 0.30, C is Ca, b is 0.05 to 0.25, z is 0.50 to 1, D is Ta, and c is 0.4 to 0.6. In some examples, x is 0.15 to 0.7, B is Ga, a is 0.05 to 0.8, y is 0.05 to 0.30, C is Ca, b is 0.05 to 0.25, z is 0.50 to 1, D is Ta, and c is 0.4 to 0.6. In some examples, x is 0.15 to 0.7, B is Al, a is 0.05 to 0.15, y is 0.05 to 0.30, C is Ba, b is 0.05 to 0.10, z is 0.50 to 1, D is Ta, and c is 0.4 to 0.6. In some examples, x is 0.15 to 0.7, B is Ga, a is 0.05 to 0.8, y is 0.05 to 0.30, C is Ba, b is 0.05 to 0.10, z is 0.50 to 1, D is Ta, and c is 0.4 to 0.6. In some examples, x is 0.15 to 0.7, B is Al, a is 0.05 to 0.15, y is 0.05 to 0.30, C is Sr, b is 0.25 to 0.30, z is 0.50 to 1, D is Ta, and c is 0.4 to 0.6. In some examples, x is 0.15 to 0.7, B is Ga, a is 0.05 to 0.8, y is 0.05 to 0.30, C is Sr, b is 0.25 to 0.30, z is 0.50 to 1, D is Ta, and c is 0.4 to 0.6. In some examples, x is 0.15 to 0.7, B is Al, a is 0.05 to 0.15, y is 0.05 to 0.30, C is Mg, b is 0.22 to 0.28, z is 0.50 to 1, D is Ta, and c is 0.4 to 0.6. And, in some examples, x is 0.15 to 0.7, B is Ga, a is 0.05 to 0.8, y is 0.05 to 0.30, C is Mg, b is 0.22 to 0.28, z is 0.50 to 1, D is Ta, and c is 0.4 to 0.6.

In some embodiments, D is Nb, and c is 0.2 to 0.4. For example, x is 0.15 to 0.7, B is Al, a is 0.05 to 0.15, y is 0.05 to 0.30, C is Ca, b is 0.05 to 0.25, z is 0.50 to 1, D is Nb, and c is 0.2 to 0.4. In some examples, x is 0.15 to 0.7, B is Ga, a is 0.05 to 0.8, y is 0.05 to 0.30, C is Ca, b is 0.05 to 0.25, z is 0.50 to 1, D is Nb, and c is 0.2 to 0.4. In some examples, x is 0.15 to 0.7, B is Al, a is 0.05 to 0.15, y is 0.05 to 0.30, C is Ba, b is 0.05 to 0.10, z is 0.50 to 1, D is Nb, and c is 0.2 to 0.4. In some examples, x is 0.15 to 0.7, B is Ga, a is 0.05 to 0.8, y is 0.05 to 0.30, C is Ba, b is 0.05 to 0.10, z is 0.50 to 1, D is Nb, and c is 0.2 to 0.4. In some examples, x is 0.15 to 0.7, B is Al, a is 0.05 to 0.15, y is 0.05 to 0.30, C is Sr, b is 0.25 to 0.30, z is 0.50 to 1, D is Nb, and c is 0.2 to 0.4. In some examples, x is 0.15 to 0.7, B is Ga, a is 0.05 to 0.8, y is 0.05 to 0.30, C is Sr, b is 0.25 to 0.30, z is 0.50 to 1, D is Nb, and c is 0.2 to 0.4. In some examples, x is 0.15 to 0.7, B is Al, a is 0.05 to 0.15, y is 0.05 to 0.30, C is Mg, b is 0.22 to 0.28, z is 0.50 to 1, D is Nb, and c is 0.2 to 0.4. And, in some examples, x is 0.15 to 0.7, B is Ga, a is 0.05 to 0.8, y is 0.05 to 0.30, C is Mg, b is 0.22 to 0.28, z is 0.50 to 1, D is Nb, and c is 0.2 to 0.4.

In some embodiments, D is Ti, and c is 0.8 to 1.0. For example, x is 0.15 to 0.7, B is Al, a is 0.05 to 0.15, y is 0.05 to 0.30, C is Ca, b is 0.05 to 0.25, z is 0.50 to 1, D is Ti, and c is 0.8 to 1.0. In some examples, x is 0.15 to 0.7, B is Ga, a is 0.05 to 0.8, y is 0.05 to 0.30, C is Ca, b is 0.05 to 0.25, z is 0.50 to 1, D is Ti, and c is 0.8 to 1.0. In some examples, x is 0.15 to 0.7, B is Al, a is 0.05 to 0.15, y is 0.05 to 0.30, C is Ba, b is 0.05 to 0.10, z is 0.50 to 1, D is Ti, and c is 0.8 to 1.0. In some examples, x is 0.15 to 0.7, B is Ga, a is 0.05 to 0.8, y is 0.05 to 0.30, C is Ba, b is 0.05 to 0.10, z is 0.50 to 1, D is Ti, and c is 0.8 to 1.0. In some examples, x is 0.15 to 0.7, B is Al, a is 0.05 to 0.15, y is 0.05 to 0.30, C is Sr, b is 0.25 to 0.30, z is 0.50 to 1, D is Ti, and c is 0.8 to 1.0. In some examples, x is 0.15 to 0.7, B is Ga, a is 0.05 to 0.8, y is 0.05 to 0.30, C is Sr, b is 0.25 to 0.30, z is 0.50 to 1, D is Ti, and c is 0.8 to 1.0. In some examples, x is 0.15 to 0.7, B is Al, a is 0.05 to 0.15, y is 0.05 to 0.30, C is Mg, b is 0.22 to 0.28, z is 0.50 to 1, D is Ti, and c is 0.8 to 1.0. And, in some examples, x is 0.15 to 0.7, B is Ga, a is 0.05 to 0.8, y is 0.05 to 0.30, C is Mg, b is 0.22 to 0.28, z is 0.50 to 1, D is Ti, and c is 0.8 to 1.0.

In some embodiments, D is W, and c is 0.2 to 0.4. For example, x is 0.15 to 0.7, B is Al, a is 0.05 to 0.15, y is 0.05 to 0.30, C is Ca, b is 0.05 to 0.25, z is 0.50 to 1, D is W, and c is 0.2 to 0.4. In some examples, x is 0.15 to 0.7, B is Ga, a is 0.05 to 0.8, y is 0.05 to 0.30, C is Ca, b is 0.05 to 0.25, z is 0.50 to 1, D is W, and c is 0.2 to 0.4. In some examples, x is 0.15 to 0.7, B is Al, a is 0.05 to 0.15, y is 0.05 to 0.30, C is Ba, b is 0.05 to 0.10, z is 0.50 to 1, D is W, and c is 0.2 to 0.4. In some examples, x is 0.15 to 0.7, B is Ga, a is 0.05 to 0.8, y is 0.05 to 0.30, C is Ba, b is 0.05 to 0.10, z is 0.50 to 1, D is W, and c is 0.2 to 0.4. In some examples, x is 0.15 to 0.7, B is Al, a is 0.05 to 0.15, y is 0.05 to 0.30, C is Sr, b is 0.25 to 0.30, z is 0.50 to 1, D is W, and c is 0.2 to 0.4. In some examples, x is 0.15 to 0.7, B is Ga, a is 0.05 to 0.8, y is 0.05 to 0.30, C is Sr, b is 0.25 to 0.30, z is 0.50 to 1, D is W, and c is 0.2 to 0.4. In some examples, x is 0.15 to 0.7, B is Al, a is 0.05 to 0.15, y is 0.05 to 0.30, C is Mg, b is 0.22 to 0.28, z is 0.50 to 1, D is W, and c is 0.2 to 0.4. And, in some examples, x is 0.15 to 0.7, B is Ga, a is 0.05 to 0.8, y is 0.05 to 0.30, C is Mg, b is 0.22 to 0.28, z is 0.50 to 1, D is W, and c is 0.2 to 0.4.

In some embodiments, the sintered SSE material (such as any of those embodiments and examples described herein) comprises a dense layer and a porous layer, wherein the dense layer has a percent density at least about 1.5% greater than the percent density of the porous layer. For example, the dense layer has a percent density at least about 2% greater than the percent density of the porous layer.

In some embodiments, the sintered SSE material (such as any of those embodiments and examples described herein) comprises a dense layer and a porous layer, wherein the dense layer or the porous layer has a thickness of from about 500 nm to about 1000 μm.

One aspect of the invention provides a green body for forming a solid-state electrolyte (SSE), wherein the green body comprises a LLZO material wherein the LLZO material comprises less than about 10 wt % of LiHLZO by weight of the LLZO material; and a binder, wherein the green body comprises from about 30% to about 60% of binder by volume of the green body.

In some embodiments, the LLZO material is calcined.

In some embodiments, the LLZO material (e.g., the calcined material) comprises a composition of Formula (V):

Li₇₋ₓBa La_{3-y}C_{b}Zr_{2-z}D_{c}O₁₂ (V),

wherein:
B is Al or Ga;
C is Ca, Sr, Ba, or Mg;
D is Ta, Nb, W, Mo, or Ti;
−0.5<x≤1;
0<a<0.24;
0<y≤0.5;
0<b≤0.5;
0<z≤1; and
0<c≤1; where x, a, y, b, z, and c are independent of each other.

In some embodiments, x is 0.15 to 0.7.

In some embodiments, B is Al, and a is 0.05 to 0.15. For example, x is 0.15 to 0.7, B is Al, and a is 0.05 to 0.15.

In some embodiments, B is Ga, and a is 0.05 to 0.8. For example, x is 0.15 to 0.7, B is Ga, and a is 0.05 to 0.8.

In some embodiments, y is 0.05 to 0.30. For example, x is 0.15 to 0.7, B is Al, a is 0.05 to 0.15, and y is 0.05 to 0.30. In other examples, x is 0.15 to 0.7, B is Ga, a is 0.05 to 0.8, and y is 0.05 to 0.30.

In some embodiments, C is Ca, and b is 0.05 to 0.25. For example, x is 0.15 to 0.7, B is Al, a is 0.05 to 0.15, y is 0.05 to 0.30, C is Ca, and b is 0.05 to 0.25. In other examples, x is 0.15 to 0.7, B is Ga, a is 0.05 to 0.8, y is 0.05 to 0.30, C is Ca, and b is 0.05 to 0.25.

In some embodiments, C is Ba, and b is 0.05 to 0.10. For example, x is 0.15 to 0.7, B is Al, a is 0.05 to 0.15, y is 0.05 to 0.30, C is Ba, and b is 0.05 to 0.10. In other examples, x is 0.15 to 0.7, B is Ga, a is 0.05 to 0.8, y is 0.05 to 0.30, C is Ba, and b is 0.05 to 0.10.

In some embodiments, C is Sr, and b is 0.25 to 0.30. For example, x is 0.15 to 0.7, B is Al, a is 0.05 to 0.15, y is 0.05 to 0.30, C is Sr, and b is 0.25 to 0.30. In other examples, x is 0.15 to 0.7, B is Ga, a is 0.05 to 0.8, y is 0.05 to 0.30, C is Sr, and b is 0.25 to 0.30.

In some embodiments, C is Mg, and b is 0.22 to 0.28. For example, x is 0.15 to 0.7, B is Al, a is 0.05 to 0.15, y is 0.05 to 0.30, C is Mg, and b is 0.22 to 0.28. In other examples, x is 0.15 to 0.7, B is Ga, a is 0.05 to 0.8, y is 0.05 to 0.30, C is Mg, and b is 0.22 to 0.28.

In some embodiments, z is 0.50 to 1. For example, x is 0.15 to 0.7, B is Al, a is 0.05 to 0.15, y is 0.05 to 0.30, C is Ca, b is 0.05 to 0.25, and z is 0.50 to 1. In some examples, x is 0.15 to 0.7, B is Ga, a is 0.05 to 0.8, y is 0.05 to 0.30, C is Ca, b is 0.05 to 0.25, and z is 0.50 to 1. In some examples, x is 0.15 to 0.7, B is Al, a is 0.05 to 0.15, y is 0.05 to 0.30, C is Ba, b is 0.05 to 0.10, and z is 0.50 to 1. In some examples, x is 0.15 to 0.7, B is Ga, a is 0.05 to 0.8, y is 0.05 to 0.30, C is Ba, b is 0.05 to 0.10, and z is 0.50 to 1. In some examples, x is 0.15 to 0.7, B is Al, a is 0.05 to 0.15, y is 0.05 to 0.30, C is Sr, b is 0.25 to 0.30, and z is 0.50 to 1. In some examples, x is 0.15 to 0.7, B is Ga, a is 0.05 to 0.8, y is 0.05 to 0.30, C is Sr, b is 0.25 to 0.30, and z is 0.50 to 1. In some examples, x is 0.15 to 0.7, B is Al, a is 0.05 to 0.15, y is 0.05 to 0.30, C is Mg, b is 0.22 to 0.28, and z is 0.50 to 1. And, in some examples, x is 0.15 to 0.7, B is Ga, a is 0.05 to 0.8, y is 0.05 to 0.30, C is Mg, b is 0.22 to 0.28, and z is 0.50 to 1.

In some embodiments, D is Ta, and c is 0.4 to 0.6. For example, x is 0.15 to 0.7, B is Al, a is 0.05 to 0.15, y is 0.05 to 0.30, C is Ca, b is 0.05 to 0.25, z is 0.50 to 1, D is Ta, and c is 0.4 to 0.6. In some examples, x is 0.15 to 0.7, B is Ga, a is 0.05 to 0.8, y is 0.05 to 0.30, C is Ca, b is 0.05 to 0.25, z is 0.50 to 1, D is Ta, and c is 0.4 to 0.6. In some examples, x is 0.15 to 0.7, B is Al, a is 0.05 to 0.15, y is 0.05 to 0.30, C is Ba, b is 0.05 to 0.10, z is 0.50 to 1, D is Ta, and c is 0.4 to 0.6. In some examples, x is 0.15 to 0.7, B is Ga, a is 0.05 to 0.8, y is 0.05 to 0.30, C is Ba, b is 0.05 to 0.10, z is 0.50 to 1, D is Ta, and c is 0.4 to 0.6. In some examples, x is 0.15 to 0.7, B is Al, a is 0.05 to 0.15, y is 0.05 to 0.30, C is Sr, b is 0.25 to 0.30, z is 0.50 to 1, D is Ta, and c is 0.4 to 0.6. In some examples, x is 0.15 to 0.7, B is Ga, a is 0.05 to 0.8, y is 0.05 to 0.30, C is Sr, b is 0.25 to 0.30, z is 0.50 to 1, D is Ta, and c is 0.4 to 0.6. In some examples, x is 0.15 to 0.7, B is Al, a is 0.05 to 0.15, y is 0.05 to 0.30, C is Mg, b is 0.22 to 0.28, z is 0.50 to 1, D is Ta, and c is 0.4 to 0.6. And, in some examples, x is 0.15 to 0.7, B is Ga, a is 0.05 to 0.8, y is 0.05 to 0.30, C is Mg, b is 0.22 to 0.28, z is 0.50 to 1, D is Ta, and c is 0.4 to 0.6.

In some embodiments, D is Nb, and c is 0.2 to 0.4. For example, x is 0.15 to 0.7, B is Al, a is 0.05 to 0.15, y is 0.05 to 0.30, C is Ca, b is 0.05 to 0.25, z is 0.50 to 1, D is Nb, and c is 0.2 to 0.4. In some examples, x is 0.15 to 0.7, B is Ga, a is 0.05 to 0.8, y is 0.05 to 0.30, C is Ca, b is 0.05 to 0.25, z is 0.50 to 1, D is Nb, and c is 0.2 to 0.4. In some examples, x is 0.15 to 0.7, B is Al, a is 0.05 to 0.15, y is 0.05 to 0.30, C is Ba, b is 0.05 to 0.10, z is 0.50 to 1, D is Nb, and c is 0.2 to 0.4. In some examples, x is 0.15 to 0.7, B is Ga, a is 0.05 to 0.8, y is 0.05 to 0.30, C is Ba, b is 0.05 to 0.10, z is 0.50 to 1, D is Nb, and c is 0.2 to 0.4. In some examples, x is 0.15 to 0.7, B is Al, a is 0.05 to 0.15, y is 0.05 to 0.30, C is Sr, b is 0.25 to 0.30, z is 0.50 to 1, D is Nb, and c is 0.2 to 0.4. In some examples, x is 0.15 to 0.7, B is Ga, a is 0.05 to 0.8, y is 0.05 to 0.30, C is Sr, b is 0.25 to 0.30, z is 0.50 to 1, D is Nb, and c is 0.2 to 0.4. In some examples, x is 0.15 to 0.7, B is Al, a is 0.05 to 0.15, y is 0.05 to 0.30, C is Mg, b is 0.22 to 0.28, z is 0.50 to 1, D is Nb, and c is 0.2 to 0.4. And, in some examples, x is 0.15 to 0.7, B is Ga, a is 0.05 to 0.8, y is 0.05 to 0.30, C is Mg, b is 0.22 to 0.28, z is 0.50 to 1, D is Nb, and c is 0.2 to 0.4.

In some embodiments, D is Ti, and c is 0.8 to 1.0. For example, x is 0.15 to 0.7, B is Al, a is 0.05 to 0.15, y is 0.05 to 0.30, C is Ca, b is 0.05 to 0.25, z is 0.50 to 1, D is Ti, and c is 0.8 to 1.0. In some examples, x is 0.15 to 0.7, B is Ga, a is 0.05 to 0.8, y is 0.05 to 0.30, C is Ca, b is 0.05 to 0.25, z is 0.50 to 1, D is Ti, and c is 0.8 to 1.0. In some examples, x is 0.15 to 0.7, B is Al, a is 0.05 to 0.15, y is 0.05 to 0.30, C is Ba, b is 0.05 to 0.10, z is 0.50 to 1, D is Ti, and c is 0.8 to 1.0. In some examples, x is 0.15 to 0.7, B is Ga, a is 0.05 to 0.8, y is 0.05 to 0.30, C is Ba, b is 0.05 to 0.10, z is 0.50 to 1, D is Ti, and c is 0.8 to 1.0. In some examples, x is 0.15 to 0.7, B is Al, a is 0.05 to 0.15, y is 0.05 to 0.30, C is Sr, b is 0.25 to 0.30, z is 0.50 to 1, D is Ti, and c is 0.8 to 1.0. In some examples, x is 0.15 to 0.7, B is Ga, a is 0.05 to 0.8, y is 0.05 to 0.30, C is Sr, b is 0.25 to 0.30, z is 0.50 to 1, D is Ti, and c is 0.8 to 1.0. In some examples, x is 0.15 to 0.7, B is Al, a is 0.05 to 0.15, y is 0.05 to 0.30, C is Mg, b is 0.22 to 0.28, z is 0.50 to 1, D is Ti, and c is 0.8 to 1.0. And, in some examples, x is 0.15 to 0.7, B is Ga, a is 0.05 to 0.8, y is 0.05 to 0.30, C is Mg, b is 0.22 to 0.28, z is 0.50 to 1, D is Ti, and c is 0.8 to 1.0.

In some embodiments, D is W, and c is 0.2 to 0.4. For example, x is 0.15 to 0.7, B is Al, a is 0.05 to 0.15, y is 0.05 to 0.30, C is Ca, b is 0.05 to 0.25, z is 0.50 to 1, D is W, and c is 0.2 to 0.4. In some examples, x is 0.15 to 0.7, B is Ga, a is 0.05 to 0.8, y is 0.05 to 0.30, C is Ca, b is 0.05 to 0.25, z is 0.50 to 1, D is W, and c is 0.2 to 0.4. In some examples, x is 0.15 to 0.7, B is Al, a is 0.05 to 0.15, y is 0.05 to 0.30, C is Ba, b is 0.05 to 0.10, z is 0.50 to 1, D is W, and c is 0.2 to 0.4. In some examples, x is 0.15 to 0.7, B is Ga, a is 0.05 to 0.8, y is 0.05 to 0.30, C is Ba, b is 0.05 to 0.10, z is 0.50 to 1, D is W, and c is 0.2 to 0.4. In some examples, x is 0.15 to 0.7, B is Al, a is 0.05 to 0.15, y is 0.05 to 0.30, C is Sr, b is 0.25 to 0.30, z is 0.50 to 1, D is W, and c is 0.2 to 0.4. In some examples, x is 0.15 to 0.7, B is Ga, a is 0.05 to 0.8, y is 0.05 to 0.30, C is Sr, b is 0.25 to 0.30, z is 0.50 to 1, D is W, and c is 0.2 to 0.4. In some examples, x is 0.15 to 0.7, B is Al, a is 0.05 to 0.15, y is 0.05 to 0.30, C is Mg, b is 0.22 to 0.28, z is 0.50 to 1, D is W, and c is 0.2 to 0.4. And, in some examples, x is 0.15 to 0.7, B is Ga, a is 0.05 to 0.8, y is 0.05 to 0.30, C is Mg, b is 0.22 to 0.28, z is 0.50 to 1, D is W, and c is 0.2 to 0.4.

In some embodiments, at least about 90% of the LLZO material has a cubic phase.

In some embodiments, at least about 90% of the LLZO material has a tetragonal phase.

In some embodiments, the binder comprises a polysiloxane, polyurethane, a polythioester, a polyacrylate, a vinyl polymer, a polyisoprene, or any combination thereof.

In some embodiments, the binder in the green body is at least partially cured.

In some embodiments, the green body further comprises a dispersant or initiator. For example, the green body comprises an initiator, wherein the initiator is a photoinitiator comprising 2,2-dimethoxy-1,2-diphenylethan-1-one, maleimides, 2-hydroxy-2-methyl-1-phenylpropanone, 1-hydroxy-cyclohexylphenylketone, oligo (2-hydroxy-2-methyl-1-[4-(1-methylvinyl)phenyl]propanone, 2-hydroxy-2-methyl-1-phenylpropan-1-one, benzophenone, 4-Phenylbenzophenone, bis[4-(dimethylamino)phenyl]methanone, methylbenzophenone, 4,4′-Bis(diethyl amino)benzophenone, 4-(2-hydroxyethoxy)phenyl-(2-hydroxy-2-methylpropyl) ketone, hydroxyacetophenone, isopropyl thioxanthone, 2,4,5-trimethylbenzoly-diphenyl phosphine oxides, bis(2,6-dimethyloxybenzoyl) 2,4,4-trimethylpentyl)phosphine oxide, bis(2,4,6-trimethylbenzoyl)-phenylphosphineoxide, benzyldimethyl ketal, camphorquinone, 2-hydroxy-2-methyl-1-(4-t-butyl)phenylpropan-1-none, bis(2,4,6-trimethylbenzoyl), 2-benzyl-2-N,N-dimethylamino-1-(4-morpholinophenyl)-1 butanone, 2-mercaptobenzoxazole, 2-methyl-1-[4-(methylthiophenyl)-2-morpholinopropanone, 2-ethylhexyl-(4-N,N-dimethyl amino)benzoate, ethyl-4-(dimethylamino)benzoate, or any combination thereof. In other examples, the green body comprises a dispersant, wherein the dispersant comprises a fish oil, a fatty acid ester, sulfonated fatty acid, or any combination thereof.

In some embodiments, the LLZO material comprises less than about 5 wt % of LiHLZO by weight of the LLZO material.

In some embodiments, the green body further comprises a dense layer and a porous layer, wherein the dense layer has a percent density that is at least 1% greater than the percent density of the porous layer.

In some embodiments, the porous layer is disposed on at least a portion of the dense layer.

In some embodiments, the porous layer further comprises a pore forming agent, and the dense layer is substantially free of any pore forming agent.

Another aspect of the present invention provides a method of forming a SSE green body for a solid-state electrolyte. The method comprises:
(a-1) reacting a precursor mixture to form a LLZO material, wherein in the precursor mixture comprises
   (i) a lithium-containing compound,
   (ii) a lanthanum-containing compound, and
   (iii) a zirconium-containing compound;
(b-1) mixing the LLZO material with a binder composition (e.g., a curable binder composition) to form a curable SSE mixture;
(c-1) forming a curable green body from the curable SSE mixture; and
(d-1) curing the curable green body to form the SSE green body.

In some implementations, the precursor further comprises (iv) a dopant. For example, the dopant may comprise Be, B, Al, Fe, Zn, Ga, Ge, Na, K, Ca, Rb, Sr, Y, Ag, Ba, Bi, Pr, Nd, Pm, Sm, Gd, Tb, Dy, Ho, Er, Tm, Ce, Mg, Si, Sc, Ti, V, Cr, Mn, Co, Ni, Cu, As, Se, Nb, Mo, Tc, Ru, Rh, Pd, Cd, In, Sn, Sb, Hf, Ta, W, Ir, Pt, Au, Hg, Tl, Pb, Eu, Te, or any combination thereof.

In some implementations, the lithium-containing compound comprises Li₂O, LiOH, LiOH H₂O, LiCl, Li₂CO₃, LiNO₃, or any combination thereof.

In some implementations, the lanthanum-containing compound comprises La₂O₃, La(OH)₃, LaCl₃, La₂(CO₃)₃, La(NO₃)₃, or any combination thereof.

In some implementations, the zirconium-containing compound comprises ZrO₂, Zr(OH)₄, ZrCl₄, Zr(OH)₂CO₃ ZrO₂, Zr(NO₃)₄.

In some implementations, the reacting step (a-1) further comprises reacting the precursor mixture by calcination to form the LLZO material. For example, the calcination may be performed at a temperature of from about 700 °C to about 1,100 °C. In other implementations, the calcination is performed at a temperature of from about 800 °C to about 1,000 °C. And, in some implementations, the calcination is performed at a temperature of from about 850 °C to about 950 °C.

In some implementations, the method further (or optionally) comprises:
(e-1) dry milling the LLZO material to form a milled LLZO material (or LLZO powder).

In some implementations, the dry milling step (e-1) is performed prior to mixing step (b-1). In some implementations, the dry milling step (e-1) further comprises
(e1-1) mixing the LLZO material with a milling additive; and
(e2-1) dry milling the LLZO material to form a milled LLZO material.

In some implementations, the dry milling step (e-1) is performed prior to mixing step (b-1). In some implementations, the dry milling step (e-1) further comprises
(e2-1a) dry milling the LLZO material in the absence of a milling additive to form a milled LLZO material.

Additional methods of forming pure-phase, milled LLZO material comprise wet milling the LLZO material in non-reactive media (e.g., non-reactive liquid milling media), with or without the use of a milling additive. Another method of forming pure-phase, milled LLZO material comprises wet milling in a reactive solvent, with or without the use of a milling additive, and subsequently further processing the powder to remove phase impurities while maintaining a desired particle size. In some instances the further processing includes heat treatments under suitable gaseous atmospheres.

In some implementations, the milling additive comprises a starch, a fatty acid, a fatty acid salt, an active polymeric dispersant, or any combination thereof. For example, the milling additive may comprise a starch. In some implementations, the starch comprises corn starch, potato starch, tapioca starch, arrowroot starch, wheat starch, potato starch, or any combination thereof.

In some implementations, the milling additive comprises a fatty acid. For example the fatty acid may comprise α-linolenic acid, stearidonic acid, eicosapentaenoic acid, cervonic acid, linoleic acid, linolelaidic acid, γ-linolenic acid, dihomo-γ-linolenic acid, arachidonic acid, docosatetraenoic acid, palmitoleic acid, vaccenic acid, paullinic acid, oleic acid, elaidic acid, gondoic acid, erucic acid, nervonic acid, mead acid, propionic acid, butyric acid, valeric acid, caproic acid, enanthic acid, caprylic acid, pelargonic acid, capric acid, undecylic acid, lauric acid, tridecylic acid, myristic acid, pentadecylic acid, palmitic acid, margaric acid, stearic acid, nonadecylic acid, arachidic acid, heneicosylic acid, behenic acid, tricosylic acid, lignoceric acid, pentacosylic acid, cerotic acid, carboceric acid, montanic acid, nonacosylic acid, melissic acid, hentriacontylic acid, lacceroic acid, psyllic acid, geddic acid, ceroplastic acid, hexatriacontylic acid, heptatriacontylic acid, octatriacontylic acid, nonatriacontylic acid, tetracontylic acid, or any combination thereof.

In some implementations, the milling additive comprises a fatty acid salt. For example, the fatty acid salt may comprise a lithium fatty acid salt, a sodium fatty acid salt, a potassium fatty acid salt, an ammonium fatty acid salt, or any combination thereof.

In some implementations, step (e1-1) is performed prior to step (e2-1). In other implementations, step (e1-1) is performed simultaneously with (e2-1). In some implementations, the dry milling step (e-1) is performed with a jet mill or an attrition mill. For example, the dry milling step (e-1) is performed with a jet mill. In other implementations, the dry milling step (e-1) is performed with an attrition mill.

In some implementations, the milled LLZO material (or LLZO powder) has a D90 particle size of less than about 10 μm. In other implementations, the milled LLZO material (or LLZO powder) has a D90 particle size of less than about 5 μm. And, in some implementations, milled LLZO material (or LLZO powder) has a D90 particle size of less than about 2.5 μm. In some implementations, the milled LLZO material (or LLZO powder) has a D90 particle size of less than about 1.5 μm. In some implementations, the milled LLZO material (or LLZO powder) has a D90 particle size of less than about 1.0 μm. In some implementations, the milled LLZO material (or LLZO powder) has a D90 particle size of less than about 0.5 μm. And, in some implementations, the milled LLZO material (or LLZO powder) has a D90 particle size of less than about 0.3 μm.

In some implementations, the binder composition comprises a binder (e.g., a polysiloxane, polyurethane, a polythioester, a polyacrylate, a vinyl polymer, a polyisoprene, or any combination thereof).

In some implementations, the binder composition comprises a binder (e.g., a polysiloxane, polyurethane, a polythioester, a polyacrylate, a vinyl polymer, a polyisoprene, or any combination thereof) and an initiator. For example, the binder composition comprises a binder and an initiator, wherein at least a portion of the binder composition undergoes polymerization and/or cross-linking when the curable green body cured with UV radiation, heat, electron beam (e-beam) radiation, or any combination thereof.

In some implementations, the binder composition comprises (i) at least one monomer, at least one oligomer, or at least one polymer, and (ii) at least one of an initiator and a dispersant, wherein at least a portion of the binder composition forms a polymer or cross-linked polymer material upon curing (e.g., curing with ultraviolet (UV) radiation, heat, electron beam (e-beam) radiation, or any combination thereof). In some examples, the curable SSE mixture comprises an LLZO material (such as any of the LLZO materials described herein) and a binder composition, wherein the binder composition comprises (i) at least one monomer, at least one oligomer, or at least one polymer, and (ii) an initiator (e.g., a photoinitiator). In some examples, the curable SSE mixture comprises (i) at least one monomer, at least one oligomer, or at least one polymer, (ii) an initiator (e.g., a photoinitiator), and (iii) a dispersant. For example, the curable SSE mixture comprises (i) at least one monomer, at least one oligomer, or at least one polymer, (ii) a photoinitiator comprising 2,2-dimethoxy-1,2-diphenylethan-1-one, maleimides, 2-hydroxy-2-methyl-1-phenylpropanone, 1-hydroxy-cyclohexylphenylketone, oligo(2-hydroxy-2-methyl-1-[4-(1-methylvinyl)phenyl]propanone, 2-hydroxy-2-methyl-1-phenylpropan-1-one, benzophenone, 4-Phenylbenzophenone, bis[4-(dimethylamino)phenyl]methanone, methylbenzophenone, 4,4′-Bis(diethyl amino)benzophenone, 4-(2-hydroxyethoxy)phenyl-(2-hydroxy-2-methylpropyl)ketone, hydroxyacetophenone, isopropyl thioxanthone, 2,4,5-trimethylbenzoly-diphenyl phosphine oxides, bis(2,6-dimethyloxybenzoyl) 2,4,4-trimethylpentyl)phosphine oxide, bis(2,4,6-trimethylbenzoyl)-phenylphosphineoxide, benzyldimethyl ketal, camphorquinone, 2-hydroxy-2-methyl-1-(4-t-butyl)phenylpropan-1-none, bis(2,4,6-trimethylbenzoyl), 2-benzyl-2-N,N-dimethylamino-1-(4-morpholinophenyl)-1 butanone, 2-mercaptobenzoxazole, 2-methyl-1-[4-(methylthiophenyl)-2-morpholinopropanone, 2-ethylhexyl-(4-N,N-dimethyl amino)benzoate, ethyl-4-(dimethylamino)benzoate, or any combination thereof, and (iii) a dispersant.

In some implementations, the binder composition comprises a cross-linkable polymer material and an initiator (e.g., a photoinitiator). In some implementations, the binder composition comprises a dispersant, a plasticizer, or any combination thereof.

In some implementations, the forming step (c-1) further comprises casting a layer of curable SSE mixture onto a substrate, wherein the layer has a thickness of from about 750 nm to about 1000 μm.

Some implementations further comprise casting a second layer comprising a second SSE mixture to substantially cover the first layer, wherein the second SSE mixture comprising a pore forming agent.

In some implementations, the curing step (d-1) further comprises curing the curable green body with ultraviolet (UV) radiation, heat, electron beam (e-beam) radiation, or any combination thereof to form the SSE green body. In other implementations, the curing step (d-1) comprises the addition of a chemical cross-linking agent or hardener. In other implementations, the curing step (d-1) further comprises curing the curable green body with UV radiation to form the SSE green body. For example, the curing step may be performed with UV radiation from a UV lamp. In some implementations, the UV lamp emits UV light at a wavelength of from about 10 nm to about 500 nm (e.g., from about 250 nm to about 440 nm).

Another aspect of the present invention provides a green body for forming a solid-state electrolyte (SSE). The green body comprises a LLZO material and a cured binder. The green body exhibits an areal shrinkage of less than about 60% when sintered.

In some embodiments, the green body exhibits an areal shrinkage of less than about 55% when sintered. In other embodiments, the green body exhibits an areal shrinkage of less than about 50% when sintered. In some embodiments, the green body exhibits an areal shrinkage of less than about 45% when sintered. In some embodiments, the green body exhibits an areal shrinkage of less than about 40% when sintered. In some embodiments, the green body exhibits an areal shrinkage of less than about 35% when sintered. In some embodiments, the green body exhibits an areal shrinkage of less than about 30% when sintered. In some embodiments, the green body exhibits an areal shrinkage of less than about 25% when sintered. And, in some embodiments, the green body exhibits an areal shrinkage of less than about 20% when sintered.

In some embodiments, the LLZO material (e.g., a calcined LLZO material) comprises a LLZO powder, a doped LLZO powder, or any combination thereof. In other embodiments, the LLZO material comprises a LLZO powder. And, in some embodiments, the LLZO material comprises a doped LLZO powder.

In some embodiments, the doped LLZO powder comprises a dopant For example, the dopant may comprise Be, B, Al, Fe, Zn, Ga, Ge, Na, K, Ca, Rb, Sr, Y, Ag, Ba, Bi, Pr, Nd, Pm, Sm, Gd, Tb, Dy, Ho, Er, Tm, Ce, Mg, Si, Sc, Ti, V, Cr, Mn, Co, Ni, Cu, As, Se, Nb, Mo, Tc, Ru, Rh, Pd, Cd, In, Sn, Sb, Hf, Ta, W, Ir, Pt, Au, Hg, Ti, Pb, Eu, Te, or any combination thereof

In some embodiments, the doped LLZO powder comprises a composition of Formula (I):

M1₇₋ₓD1ₐM2_{3-y}D2_{b}M3_{2-z}D3_{c}O_{12-w}D4_{d} (I)

wherein
M1 is Li;
M2 is La;
M3 is Zr;
D1 is Be, B, Al, Fe, Zn, Ga, Ge, or any combination thereof;
D2 is Na, K, Ca, Rb, Sr, Y, Ag, Ba, Bi, Pr, Nd, Pm, Sm, Gd, Tb, Dy, Ho, Er, Tm, Zn, Ce, or any combination thereof;
D3 is Mg, Si, Sc, Ti, V, Cr, Mn, Co, Ni, Cu, Ge, As, Se, Nb, Mo, Tc, Ru, Rh, Pd, Cd, In, Sn, Sb, Hf, Ta, W, Ir, Pt, Au, Hg, Tl, Pb, Ce, Eu, Te, Y, Sr, Ca, Ba, Gd, Ge, or any combination thereof; and
D4 is F, Cl, Br, I, S, Se, Te, N, P, or any combination thereof;
   provided that
0≤w≤2;
—0.5<x≤3;
0≤y≤3;
0≤z≤2;
0≤a≤2;
0≤b≤3;
0≤c≤2; and
0≤d≤2;
   wherein at least one of a, b, c, and d is >0.

In some embodiments, the LLZO material has a D90 particle size of less than about 10 μm. In other embodiments, the LLZO material has a D90 particle size of less than about 5 μm. And, in some embodiments, the LLZO material has a D90 particle size of less than about 2.5 μm.

In some embodiments, the binder is cured by exposure to ultraviolet (UV) radiation. In other embodiments, the cured binder comprises a cross-linked polymer material.

In some embodiments, the green body has a thickness of from about 500 nm to about 1000 μm. In some embodiments, the green body has a thickness of from about 1 μm to about 100 μm. In other embodiments, the green body has a thickness of from about 1 μm to about 75 μm. In some embodiments, the green body has a thickness of from about 1 μm to about 50 μm. In some embodiments, the green body has a thickness of from about 1 μm to about 25 μm. In other embodiments, the green body has a thickness of from about 1 μm to about 80 μm. In some embodiments, the green body has a thickness of from about 20 μm to about 80 μm. And, in some embodiments, the green body has a thickness of from about 20 μm to about 60 μm.

In some embodiments, the green body further comprises a first layer and a second layer at least partially disposed on the first layer. In such embodiments, the LLZO material is further defined as a first LLZO material and the binder is further defined as a first binder. The first layer comprises the first LLZO material and the first binder. The second layer comprises a second LLZO material and a second binder.

In some embodiments, the second layer further comprises a pore forming agent. In other embodiments, the first layer is substantially free of a pore forming agent.

In some embodiments, the first layer has a thickness of from about 500 nm to about 1000 μm. In some embodiments, the second layer has a thickness of from about 1 μm to about 10 μm. In some embodiments, the second layer has a thickness of from about 10 μm to about 50 μm. In some embodiments, the first layer has a thickness of from about 1 μm to about 100 μm. In other embodiments, the first layer has a thickness of from about 1 μm to about 75 μm. In some embodiments, the first layer has a thickness of from about 1 μm to about 50 μm. And, in some embodiments, the first layer has a thickness of from about 1 μm to about 25 μm.

In some embodiments, the second layer has a thickness of from about 500 nm to about 1000 μm. In some embodiments, the second layer has a thickness of from about 1 μm to about 10 μm. In some embodiments, the second layer has a thickness of from about 10 μm to about 50 μm. In some embodiments, the second layer has a thickness of from about 1 μm to about 100 μm. In other embodiments, the second layer has a thickness of from about 1 μm to about 80 μm. In some embodiments, the second layer has a thickness of from about 20 μm to about 80 μm. And, in some embodiments, the second layer has a thickness of from about 20 μm to about 60 μm.

### BRIEF DESCRIPTION OF THE DRAWINGS

The figures below are provided by way of example and are not intended to limit the scope of the claimed invention.

FIG. 1 is a flow chart of a method of calculating an areal shrinkage of a green body according to one implementation of the invention.

FIG. 2 is a flow chart of a method of forming a green body according to one implementation of the invention.

FIG. 3 is a flow chart of a method of forming a green body according to another implementation of the invention.

FIG. 4A shows X-ray powder diffraction (XRPD) patterns for LLZO materials according to Examples 1 and 2.

FIG. 4B is a close-up view of the XRPD patters of FIG. 4A.

FIG. 5A shows X-ray powder diffraction (XRPD) patterns for additional LLZO materials according to Examples 1 and 2.

FIG. 5B is a close-up view of the XRPD patters of FIG. 5A.

### DETAILED DESCRIPTION

The present invention provides a green body for forming a solid-state electrolyte and methods of forming the same.

As used herein, the following definitions shall apply unless otherwise indicated.

### I. DEFINITIONS

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

As used herein, when an element is referred to as being “on,” “engaged to,” “connected to,” “attached to,” or “coupled to” another element, it may be directly on, engaged, connected, attached, or coupled to the other element, or intervening elements may be present. In contrast, when an element is referred to as being “directly on,” “directly engaged to,” “directly connected to,” “directly attached to,” or “directly coupled to” another element, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

As used herein, the term “green body” refers to an unsintered body (e.g., a tape and/or film) that comprises a LLZO material and a binder. In some embodiments, the green body is dry (i.e., the green body is substantially free (e.g., comprises less than 1 wt %, less than 0.75 wt %, less than 0.50 wt %, less than 0.25 wt %, less than 0.1 wt %, less than 0.05 wt %, or less than 0.01 wt % by weight of the green body, or no detectable trace) of all volatile or high vapor pressure solvents).

As used herein, the terms “lithium lanthanum zirconium oxide green body” and “SSE green body” are used interchangeably herein and refer to an unsintered body (e.g., a tape and/or film) that comprises a LLZO material and a binder. In some embodiments, the SSE green body is dry (i.e., the SSE green body is free of all volatile or high vapor pressure solvents).

As used herein, the term “LLZO material” refers to a material that comprises a doped or undoped LLZO cubic garnet phase or tetragonal garnet phase. In some embodiments, the LLZO material comprises a LLZO powder, a doped LLZO powder, or any combination thereof.

As used herein, the term “binder” refers to a material that facilitates adhesion of another material (e.g., the LLZO material) and is removable from a green body via debinding and/or sintering. In some embodiments, the binder is a cured binder.

As used herein, the term “cured binder” refers to a material that is at least partially cured and is removable from the green body via debinding. In some embodiments, the cured binder is cured (or partially cured) by exposure to ultraviolet (UV) radiation. In some embodiments, the cured binder has a glass transition temperature that is greater than room temperature.

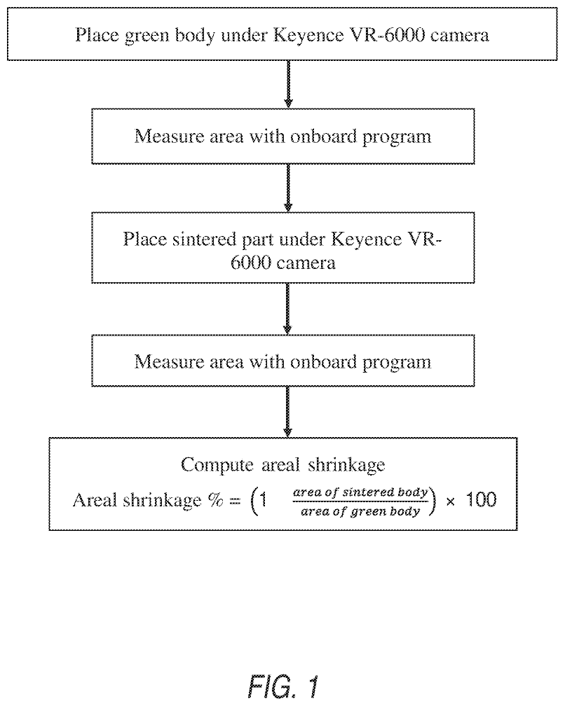

As used herein, the term “areal shrinkage” refers to an areal shrinkage percent exhibited by a green body after sintering (i.e., when the green body has been sintered to form a sintered body). The areal shrinkage percent is calculated according to formula (1):

$$Areal shrinkage \% = ( 1 - \frac{area of sintered body}{area of green body} ) \times 100 , \qquad ( 1 )$$

wherein the area refers to an area of a surface that is perpendicular to a thickness of the green body/sintered body. One example of a method of calculating areal shrinkage of a green body is provided in the flow chart depicted in FIG. 1.

When the sintered body includes minor cracking and/or damage that may otherwise distort the area of the sintered body, the area of the sintered body is approximated by the dimensions (e.g., length and width) of the surface perpendicular to a thickness of the sintered body. In other words, the area of the sintered body is approximated based on what the area would have been if the sintered body was free of any cracks or damage.

As used herein, the term “volumetric shrinkage” refers to volumetric shrinkage percent exhibited by a green body after sintering (i.e., when the green body has been sintered to form a sintered body). The volumetric shrinkage percent is calculated according to formula (2):

$$Volumetric Shrinkage \% = ( 1 - \frac{{v}_{2}}{{v}_{1}} ) * 100 = ( 1 - \frac{{m}_{2} {ρ}_{1}}{{m}_{1} {ρ}_{2}} ) * 100 , \qquad ( 2 )$$

wherein
v₁ is a volume of the green body;
m₁ is a mass of the green body;
ρ₁ is a density of the green body;
v₂ is a volume of the sintered body;
m₂ is a mass of the sintered body; and
ρ₂ is a density of the sintered body.

As used herein, the term “theoretical density” refers to a maximum achievable density of a material (e.g., a LLZO material) assuming no internal voids (e.g., pores) or impurities. The theoretical density is calculated according to formula (3):

$$Theoretical Density of LLZO material = \frac{molecular weight of one unit cell of LLZO material}{{( lattice parameter a )}^{2} ( lattice parameter c )} , \qquad ( 3 )$$

wherein, if the LLZO material is a cubic garnet phase, then lattice parameter a is equal to lattice parameter c.

For a green body (e.g., a SSE green body), the theoretical density (i.e., ρ_{green body}) is calculated according to formula (3-1):

$${ρ}_{green body} = \frac{1}{\sum \frac{wt {\%}_{i}}{{ρ}_{i}}} , \qquad ( 3 - 1 )$$

wherein
i represents a component of the green body (e.g., a cured binder, a LLZO material, etc.);
wt % refers to a w/w % of the component, i, based on the total weight of the green body; and
ρ₁ is a theoretical density of the component i.

For example, for a two-component green body (e.g., a LLZO material and a binder), the theoretical density (i.e., ρ_{green body}) is calculated according to formula (3-2):

$${ρ}_{green body} = \frac{1}{\frac{wt {\%}_{LLZO}}{{ρ}_{LLZO}} + \frac{wt {\%}_{binder}}{{ρ}_{binder}}} , \qquad ( 3 - 2 )$$

wherein
wt %_{LLZO} is a wt % of the LLZO material based on the total weight of the green body;
ρ_{LLZO} is a theoretical density of the LLZO material;
wt %_{binder} is a wt % of the binder based on the total weight of the green body; and
ρ_{binder} is a theoretical density of the binder (e.g., a cured binder).

As another example, for a three-component green body (e.g., a LLZO material, a binder, and a pore forming agent), the theoretical density (i.e., ρ_{green body}) is calculated according to formula (3-3):

$${ρ}_{green body} = \frac{1}{\frac{wt {\%}_{LLZO}}{{ρ}_{LLZO}} + \frac{wt {\%}_{binder}}{{ρ}_{binder}} + \frac{wt {\%}_{poreformer}}{{ρ}_{poreformer}}} , \qquad ( 3 - 3 )$$

wherein
wt %_{LLZO} is a wt % of the LLZO material based on the total weight of the green body;
ρ_{LLZO} is a theoretical density of the LLZO material;
wt %_{binder} is a wt % of the binder based on the total weight of the green body;
ρ_{binder} is a theoretical density of the binder (e.g., a cured binder);
wt %_{poreformer} is a wt % of the pore forming agent based on the total weight of the green body; and
ρ_{poreformer} is a theoretical density of the pore forming agent.

As used herein, the term “percent density” is calculated according to formula (4):

$$\% Density ( \% ρ ) = \frac{{ρ}_{measured}}{{ρ}_{theoretical}} \times 100 , \qquad ( 4 )$$

wherein
ρ_{measured} is a measured density of a material (e.g., a green body) as measured by one of various methods (e.g., geometric, Archimedes, pycnometry); and
ρ_{theoretical} is a theoretical density of the material (e.g., green body).

Unless otherwise stated herein, any “ρ_{measured}” values were measured according to ASTM D 1475-98, ASTM B923-22, or ASTM D792-20, as applicable.

Unless otherwise stated herein, any “ρ_{green body}” values were calculated for green bodies that were dry (i.e., the green bodies were free of all volatile or high vapor pressure solvents).

As used herein, the term “characteristic peaks” when referring to the peaks in an X-ray powder diffraction (XRPD) pattern for a LLZO material of a SSE green body described herein refer to a collection of certain peaks whose values of 20 across a range of 0° to 80° are, as a whole, uniquely assigned to the LLZO material.

As used herein, the term “a substantially pure sample of the LLZO material” refers to a sample of LLZO material (e.g., a LLZO powder or a doped LLZO powder) that is substantially free of impurities and/or secondary phases (e.g., comprising less than about 5%, less than about 4%, less than about 3%, less than about 2%, or less than about 1%, less than about 0.5%, less than about 0.25%, less than about 0.1%, less than about 0.01%, or less than about 0.001% of impurities and/or secondary phases). In some embodiments, the substantially pure sample of the LLZO material may refer to a sample of the LLZO material immediately following the synthesis thereof (e.g., calcination).

As used herein, the term “initiator” refers to a chemical compound that initiates polymerization reactions in the presence of monomers or cross-linking reactions in the presence of polymers.

As used herein, the term “photoinitiator” refers to a chemical compound that forms a reactive species when exposed to radiation (e.g., ultraviolet (UV) radiation or visible radiation). The reactive species formed from the photoinitiator may initiate cross-linking or polymerization.

As used herein, the term “decomposed photoinitiator” refers to any unreactive species that result from a photoinitiator after exposure to radiation. The decomposed photoinitiator may result from a reactive species that initiates and/or propagates polymerization and/or cross-linking and is thereby quenched (i.e., rendered unreactive). Alternatively, the decomposed photoinitiator may be a stable (i.e., unreactive) species formed from the photoinitiator immediately upon exposure of the photoinitiator to radiation (i.e., without any subsequent or intervening reactions occurring).

As used herein, the term “protonated LLZO (LiHLZO)” refers to a LLZO material wherein some amount (x) of protons (i.e., H⁺) are substituted for x lithium ions in the LLZO lattice. LiHLZO is represented by Li₇₋ₓHₓLa₃Zr₂O₂ in equation (A-1). LiHLZO is a phase impurity that reduces the density of the LLZO material. LiHLZO may result from the LLZO material reacting with solvents (e.g., protic solvents (e.g., water, as shown in reaction (A-1) below, alcohols, as shown in reactions (B) and (C) below, or acids) or any solvents having a pKₐ of less than about 22, less than about 21, less than about 20, or less than about 19). Alternatively, LiHLZO may result from the LLZO material reacting with moisture (i.e., water molecules) present in air or solvents. Without wishing to be bound by theory, it is believed that LiHLZO results from, among other reactions, reactions (A-1), (B), and (C) as set forth below:

Li₇La₃Zr₂O₁₂+xH₂O→Li₇₋ₓHₓLa₃Zr₂O₁₂+xLi₂O (A-1);

2LiOH+CO₂→Li₂CO₃+H₂O (A-2);

Li₇La₃Zr₂O₁₂+xC₂H₅OH→Li₇₋ₓHₓLa₃Zr₂O₁₂+xC₂H₅OLi (B); and

Li₇La₃Zr₂O₁₂+xC₃H₇OH→Li₇₋ₓHₓLa₃Zr₂O₁₂+xC₃H₇OLi (C).

It will be appreciated that, in embodiments where the LLZO material comprises a doped LLZO material, protons replace the lithium ions in the doped LLZO material in a substantially similar manner.

As used herein, the term “D90 particle size” refers to a particle size below which 90% of the corresponding material particles (e.g. a LLZO powder or a doped LLZO powder) fall by volume. The D90 particle size may be determined with any suitable particle size analyzer. For example, the D90 particle size may be determined with a Horiba LA-910 particle size analyzer (Horiba Instruments, Irvine, Calif.).

### II. GREEN BODY

In one aspect, the present invention provides a green body for a solid-state electrolyte. The green body comprises a LLZO material and a binder.

### A. LLZO Material

In some embodiments, the LLZO material of comprises a lithium perovskite material, Li₃N, Li-β-alumina, lithium super-ionic conductors (LISICON), Li_{2.88}PO_{3.86}N_{0.14} (LiPON), sodium super-ionic conductors (NASICON), Li₉AlSiO₈, Li₁₀GeP₂S₁₂, lithium garnet SSE materials, doped lithium garnet SSE materials, lithium garnet composite materials, or any combination thereof. In some embodiments, the lithium garnet SSE material is cation-doped Li₅La₃M¹₂O₁₂, where M¹ is Nb, Zr, Ta, or any combination thereof, cation-doped Li₆La₂BaTa₂O₁₂, cation-doped Li₇La₃Zr₂O₁₂, and cation-doped Li₆BaY₂M¹₂O₁₂, where cation dopants are barium, yttrium, zinc, or combinations thereof, and the like. In other embodiments, the lithium garnet SSE material is Li₅La₃Nb₂O₁₂, Li₅La₃Ta₂O₁₂, Li₇La₃Zr₂₀₂, Li₆La₂SrNb₂O₁₂, Li₆La₂BaNb₂O₁₂, Li₆La₂SrTa₂O₁₂, Li₆La₂BaTa₂O₁₂, Li₇Y₃Zr₂O₁₂, Li_{6.4}Y₃Zr_{1.4}Ta_{0.6}O₁₂, Li_{6.5}La_{2.5}Ba_{0.5}TaZrO₁₂, Li₆BaY₂M¹₂O₁₂, Li₇Y₃Zr₂O₁₂, Li_{6.75}BaLa₂Nb_{1.75}Zn_{0.25}O₁₂, Li_{6.75}BaLa₂Ta_{1.75}Zn_{0.25}O₁₂, or any combination thereof.

In some embodiments, the LLZO material is a calcined material. For example, the LLZO material comprises a doped or undoped LLZO material having a cubic garnet phase. In other examples, the LLZO material comprises a doped or undoped LLZO material having a tetrahedral phase. In some embodiments, the LLZO material comprises a LLZO powder, a doped LLZO powder, or any combination thereof. In other embodiments, the LLZO material comprises a LLZO powder. In some embodiments, the LLZO material comprise a doped LLZO powder. And, in some embodiments, the LLZO material comprises a LLZO powder and a doped LLZO powder.

In some embodiments, the LLZO powder is substantially free of a dopant (e.g., the LLZO powder comprises less than 0.5%, less than 0.25%, less than 0.1%, less than 0.01%, or less than 0.001% of a dopant by weight of the LLZO powder). In other embodiments, the LLZO powder is free of a dopant.

In some embodiments, the doped LLZO powder comprises a dopant. For example, the dopant may comprise Be, B, Al, Fe, Zn, Ga, Ge, Na, K, Ca, Rb, Sr, Y, Ag, Ba, Bi, Pr, Nd, Pm, Sm, Gd, Tb, Dy, Ho, Er, Tm, Ce, Mg, Si, Sc, Ti, V, Cr, Mn, Co, Ni, Cu, As, Se, Nb, Mo, Tc, Ru, Rh, Pd, Cd, In, Sn, Sb, Hf, Ta, W, Ir, Pt, Au, Hg, Tl, Pb, Eu, Te, or any combination thereof. In some embodiments, the dopant comprises Be. In other embodiments, the dopant comprises B. In some embodiments, the dopant comprises Al. In some embodiments, the dopant comprises Fe. In other embodiments, the dopant comprises Zn. In some embodiments, the dopant comprises Ga. In some embodiments, the dopant comprises Ge. In some embodiments, the dopant comprises Na. In some embodiments, the dopant comprises K. In other embodiments, the dopant comprises Ca. In some embodiments, the dopant comprises Rb. In some embodiments, the dopant comprises Sr. In some embodiments, the dopant comprises Y. In some embodiments, the dopant comprises Ag. In some embodiments, the dopant comprises Ba. In some embodiments, the dopant comprises Bi. In some embodiments, the dopant comprises Pr. In other embodiments, the dopant comprises Nd. In some embodiments, the dopant comprises Pm. In some embodiments, the dopant comprises Sm. In some embodiments, the dopant comprises Gd. In some embodiments, the dopant comprises Tb. In some embodiments, the dopant comprises Dy. In some embodiments, the dopant comprises Ho. In some embodiments, the dopant comprises Er. In other embodiments, the dopant comprises Tm. In some embodiments, the dopant comprises Ce. In some embodiments, the dopant comprises Mg. In some embodiments, the dopant comprises Si. In some embodiments, the dopant comprises Sc. In some embodiments, the dopant comprises Ti. In some embodiments, the dopant comprises V. In some embodiments, the dopant comprises Cr. In some embodiments, the dopant comprises Mn. In some embodiments, the dopant comprises Co. In some embodiments, the dopant comprises Ni. In some embodiments, the dopant comprises Cu. In other embodiments, the dopant comprises As. In some embodiments, the dopant comprises Se. In some embodiments, the dopant comprises Nb. In some embodiments, the dopant comprises Mo. In some embodiments, the dopant comprises Tc. In some embodiments, the dopant comprises Ru. In other embodiments, the dopant comprises Rh. In some embodiments, the dopant comprises Pd. In some embodiments, the dopant comprises Cd. In some embodiments, the dopant comprises In. In some embodiments, the dopant comprises Sn. In some embodiments, the dopant comprises Sb. In some embodiments, the dopant comprises Hf. In other embodiments, the dopant comprises Ta. In some embodiments, the dopant comprises W. In some embodiments, the dopant comprises Ir. In some embodiments, the dopant comprises Pt. In some embodiments, the dopant comprises Au. In some embodiments, the dopant comprises Hg. In some embodiments, the dopant comprises Tl. In some embodiments, the dopant comprises Pb. In other embodiments, the dopant comprises Eu. And, in some embodiments, the dopant comprises Te.

In some embodiments, the doped LLZO powder comprises a composition of Formula (I):

M1₇₋ₓD1ₐM2_{3-y}D2_{b}M3_{2-z}D3_{c}O_{12-w}D4_{d} (I)

wherein
M1 is Li;
M2 is La;
M3 is Zr;
D1 is Be, B, Al, Fe, Zn, Ga, Ge, or any combination thereof;
D2 is Na, K, Ca, Rb, Sr, Y, Ag, Ba, Bi, Pr, Nd, Pm, Sm, Gd, Tb, Dy, Ho, Er, Tm, Zn, Ce, or any combination thereof;
D3 is Mg, Si, Sc, Ti, V, Cr, Mn, Co, Ni, Cu, Ge, As, Se, Nb, Mo, Tc, Ru, Rh, Pd, Cd, In, Sn, Sb, Hf, Ta, W, Ir, Pt, Au, Hg, Tl, Pb, Ce, Eu, Te, Y, Sr, Ca, Ba, Gd, Ge, or any combination thereof; and
D4 is F, Cl, Br, I, S, Se, Te, N, P, or any combination thereof; provided that
0≤w≤2;
−0.5<x≤3;
0≤y≤3;
0≤z≤2;
0≤a≤2;
0≤b≤3;
0≤c≤2; and
0≤d≤2;
   wherein at least one of a, b, c, and d is >0.

For those constituents of any formula herein (e.g., D1, D2, D3 and/or D4), where the constituent can comprise a combination of atoms, combination of cations, or combination of anions, the subscript immediately following such constituent (e.g., a, b, c, and/or d) represents the aggregate pfu (per formula unit) for all atoms, anions, and/or cations in the combination (and not the pfu for the specific atom, anion and/or cation).

In other embodiments, the doped LLZO powder comprises a composition of Formula (II):

Li₇₋ₓD1ₐLa_{3-y}D2_{b}Zr_{2-z}D3_{c}O_{12-W}D4_{d} (II),

wherein:
D1 is Be, B, Al, Fe, Zn, Ga, Ge, or any combination thereof;
D2 is Na, K, Ca, Rb, Sr, Y, Ag, Ba, Bi, Pr, Nd, Pm, Sm, Gd, Tb, Dy, Ho, Er, Tm, Zn, Ce, or any combination thereof;
D3 is Mg, Si, Se, Ti, V, Cr, Mn, Co, Ni, Cu, Ge, As, Se, Nb, Mo, Te, Ru, Rh, Pd, Cd, In, Sn, Sb, Te, I, Hf, Ta, W, Ir, Pt, Au, Hg, Tl, Pb, Ce, Eu, Te, Y, Sr, Ca, Ba, Gd, Ge, or any combination thereof;
D4 is F, Cl, Br, I, S, Se, Te, or any combination thereof;
0≤w≤2, and in some embodiments 0≤w≤1, and in some embodiments 0≤w≤0.5, and in some embodiments 0≤w≤0.1;
−0.5<x≤3, and in some embodiments 0<x≤1.5;
0<y≤3, and in some embodiments 0<y≤2;
0≤z≤2, and in some embodiments 0≤z≤1.5;
0≤a≤1, and in some embodiments 0≤a≤0.24;
0≤b≤3, and in some embodiments 0≤b≤2;
0≤c≤2, and in some embodiments 0≤c≤1.5; and 0≤d≤2, and in some embodiments 0≤d≤1, and in some embodiments 0≤d≤0.5, and in some embodiments 0≤d≤0.1.

In some embodiments of compositions of Formula (II):
D1 is Al, Ga, or any combination thereof, and 0≤a≤0.15;
D2 is Ca, Sr, Ba, or any combination thereof, and 0≤b≤0.5;
D3 is Ta, Nb, W, Ti, Mo, or any combination thereof, and 0≤c≤1.0;
D4 is F, Cl, or any combination thereof, and 0≤d≤0.25;
0<x≤1.0;
0≤y≤0.5;
0<z≤1.0; and
0≤w≤0.25.

Examples of compositions of Formula (II) are set forth in Table 1.

TABLE 1
Examples of compositions of Formula (II).

| Example | Li | D1 | La | D2 | Zr | D3 | O | D4 |
|---|---|---|---|---|---|---|---|---|
| T1-1 | 6.75 | 0 | 2.75 | Ca- | 1.50 | Ta- | 12 | 0 |
| | | | | 0.25 | | 0.50 | | |
| T1-2 | 6.30 | Ga- | 2.95 | Ba- | 1.70 | Nb- | 12 | 0 |
| | | 0.15 | | 0.05 | | 0.30 | | |
| T1-3 | 6.85 | Al- | 2.70 | Sr- | 1.00 | Ti- | 12 | 0 |
| | | 0.15 | | 0.30 | | 1.00 | | |
| T1-4 | 6.30 | Ga- | 2.76 | Mg- | 1.65 | W- | 12 | 0 |
| | | 0.08 | | 0.24 | | 0.35 | | |
| T1-5 | 6.6 | Al- | 2.90 | Ca- | 1.70 | Ta- | 11.90 | F- |
| | | 0.05 | | 0.10 | | 0.30 | | 0.10 |

In other embodiments, the doped LLZO powder comprises a composition of Formula (III):

Li_{7-3x-y+z} BₓLa_{3-y}C_{y}Zr_{2-z}D_{z}O₁₂₋ₐG_{2a/n} (III),

wherein:
B is any trivalent cation (e.g. Al³⁺ or Ga³⁺) or any combination thereof (in some embodiments, the charge can be compensated by removing 3 Li for 1 trivalent B);
C is any divalent cation (e.g., Mg²⁺) or any combinations thereof; and
D is any pentavalent cation (e.g., Nb⁵⁺) or any combination thereof;
G is any anion, monovalent (e.g., F⁻), divalent (e.g. S²⁻), or trivalent (e.g. N³⁻), or G is absent; and
n is the charge of the dopant;
0<x≤0.5;
0≤y≤3;
0≤z≤2; and
0≤a≤12.

In some embodiments, B is selected from Al, Ga, H, Fe, Zn, or any combination thereof; C is Ca, Mg, Sr, Ba, Na, Ce, or any combination thereof; D is Ta, Y, Mo, Sb, Nb, W, Ge, Ti, or any combination thereof, and G is selected from F, Cl, or any combination thereof, or G is absent. In some embodiments:
0<x≤0.24;
0.1≤y≤1.5;
0.2≤z≤1; and
0≤a≤0.5.

In some embodiments, the doped LLZO powder comprises a composition of Formula (IV):

LiₙBₓ^{vB}La_{3-y}C_{y}^{vC}Zr_{2-z}D_{z}^{vD}O₁₂₋ₐGa (IV),

wherein
n=7-x(v_{B})+y(3-v_{C})+z(4-v_{D})−a/2;
v_{B} is oxidation state of dopant B, v_{C} is the oxidation state of dopant C, and v_{D} is the oxidation state of dopant D (note that in this formula, any change in vacancies and charge is balanced by the amount of lithium in the formula, but a similar approach can be used by also balancing the amount of oxygen in the formula);
B is a cation such as H⁺, Al³⁺, or Ga³⁺, or any combination thereof. In some embodiments, B is Al³⁺
C is a cation such as Ca²⁺, Ba²⁺, Sr²⁺, Mg²⁺, Rb⁺, Ce⁴⁺, or any combination thereof. In some embodiments, C is Ca²⁺
D is a cation such as Ta⁵⁺, Y³⁺, Mo⁶⁺, Nb⁵⁺, W⁶⁺, Ge⁴⁺, Ti⁴⁺, or any combination thereof. In some embodiments, D is Ta⁵⁺, Nb⁵⁺, Ti⁴⁺, or any combination thereof. In other embodiments, D is Ta⁵⁻.

G is absent or a halogen anion, such as F— or Cl—, or any combination thereof. For each of the cations listed for B, C, and D, different oxidation states of the cation may be used where applicable, to change the balance of lithium or oxygen in the system and control the final properties of the solid electrolyte as desired. Furthermore, where combinations of cations are doped at any particular site with the same or different oxidation state, Formula IV can be used adding identical terms to the equation for n. For example, if dopants for the Li site B1 and B2 were desired, then the equation for n becomes n=7-x₁(v_{B1})−x₂(v_{B2})+y(3-v_{C})+z(4-v_{D})−a/2. Similar modifications can be done for multiple C dopants, D dopants, G dopants, or combinations thereof
0<x≤0.24, and in some embodiments 0<x≤0.15, and in other embodiments 0.02<x<0.10.
0≤y≤1.0, and in some embodiments 0≤y≤0.5, and in other embodiments 0.1≤y≤0.30, and in some embodiments 0.15≤y≤0.28.
0≤z≤1.0, and in some embodiments 0≤z≤0.7, and in other embodiments 0.3≤z≤0.6, and in some embodiments 0.4≤z≤0.55.
0≤a≤1.0, and in some embodiments 0≤a≤0.1, and in other embodiments 0≤a≤0.05.

It should be appreciated that Formula (III) and Formula (IV) may be used as guidance when selecting compositions for Formula (I) and Formula (II), particularly with respect to the composition of a particular element relative to other elements. The relative compositions are useful in producing a single phase garnet product.

In some embodiments, the doped LLZO powder comprises a composition of Formula (V):

Li₇₋ₓBa La_{3-y}C_{b}Zr_{2-z}D_{c}O₁₂ (V),

wherein:
B is Al or Ga;
C is Ca, Sr, Ba, or Mg;
D is Ta, Nb, W, Mo, or Ti;
−0.5<x≤1;
0≤a≤0.24;
0≤y≤0.5;
0≤b≤0.5;
0≤z≤1; and
0≤c≤1; where x, a, y, b, z, and c are independent of each other.

For example, in some embodiments of compositions according to Formula (V):
0.2<x≤0.8;
0≤a≤0.15;
0≤y≤0.3;
0≤b≤0.3;
0≤z≤1; and
0≤c≤1.

In some embodiments, x is 0.15 to 0.7.

In some embodiments, B is Al, and a is 0.05 to 0.15. For example, x is 0.15 to 0.7, B is Al, and a is 0.05 to 0.15.

In some embodiments, B is Ga, and a is 0.05 to 0.8. For example, x is 0.15 to 0.7, B is Ga, and a is 0.05 to 0.8.

In some embodiments, y is 0.05 to 0.30. For example, x is 0.15 to 0.7, B is Al, a is 0.05 to 0.15, and y is 0.05 to 0.30. In other examples, x is 0.15 to 0.7, B is Ga, a is 0.05 to 0.8, and y is 0.05 to 0.30.

In some embodiments, C is Ca, and b is 0.05 to 0.25. For example, x is 0.15 to 0.7, B is Al, a is 0.05 to 0.15, y is 0.05 to 0.30, C is Ca, and b is 0.05 to 0.25. In other examples, x is 0.15 to 0.7, B is Ga, a is 0.05 to 0.8, y is 0.05 to 0.30, C is Ca, and b is 0.05 to 0.25.

In some embodiments, C is Ba, and b is 0.05 to 0.10. For example, x is 0.15 to 0.7, B is Al, a is 0.05 to 0.15, y is 0.05 to 0.30, C is Ba, and b is 0.05 to 0.10. In other examples, x is 0.15 to 0.7, B is Ga, a is 0.05 to 0.8, y is 0.05 to 0.30, C is Ba, and b is 0.05 to 0.10.

In some embodiments, C is Sr, and b is 0.25 to 0.30. For example, x is 0.15 to 0.7, B is Al, a is 0.05 to 0.15, y is 0.05 to 0.30, C is Sr, and b is 0.25 to 0.30. In other examples, x is 0.15 to 0.7, B is Ga, a is 0.05 to 0.8, y is 0.05 to 0.30, C is Sr, and b is 0.25 to 0.30.

In some embodiments, C is Mg, and b is 0.22 to 0.28. For example, x is 0.15 to 0.7, B is Al, a is 0.05 to 0.15, y is 0.05 to 0.30, C is Mg, and b is 0.22 to 0.28. In other examples, x is 0.15 to 0.7, B is Ga, a is 0.05 to 0.8, y is 0.05 to 0.30, C is Mg, and b is 0.22 to 0.28.

In some embodiments, z is 0.50 to 1. For example, x is 0.15 to 0.7, B is Al, a is 0.05 to 0.15, y is 0.05 to 0.30, C is Ca, b is 0.05 to 0.25, and z is 0.50 to 1. In some examples, x is 0.15 to 0.7, B is Ga, a is 0.05 to 0.8, y is 0.05 to 0.30, C is Ca, b is 0.05 to 0.25, and z is 0.50 to 1. In some examples, x is 0.15 to 0.7, B is Al, a is 0.05 to 0.15, y is 0.05 to 0.30, C is Ba, b is 0.05 to 0.10, and z is 0.50 to 1. In some examples, x is 0.15 to 0.7, B is Ga, a is 0.05 to 0.8, y is 0.05 to 0.30, C is Ba, b is 0.05 to 0.10, and z is 0.50 to 1. In some examples, x is 0.15 to 0.7, B is Al, a is 0.05 to 0.15, y is 0.05 to 0.30, C is Sr, b is 0.25 to 0.30, and z is 0.50 to 1. In some examples, x is 0.15 to 0.7, B is Ga, a is 0.05 to 0.8, y is 0.05 to 0.30, C is Sr, b is 0.25 to 0.30, and z is 0.50 to 1. In some examples, x is 0.15 to 0.7, B is Al, a is 0.05 to 0.15, y is 0.05 to 0.30, C is Mg, b is 0.22 to 0.28, and z is 0.50 to 1. And, in some examples, x is 0.15 to 0.7, B is Ga, a is 0.05 to 0.8, y is 0.05 to 0.30, C is Mg, b is 0.22 to 0.28, and z is 0.50 to 1.

In some embodiments, D is Ta, and c is 0.4 to 0.6. For example, x is 0.15 to 0.7, B is Al, a is 0.05 to 0.15, y is 0.05 to 0.30, C is Ca, b is 0.05 to 0.25, z is 0.50 to 1, D is Ta, and c is 0.4 to 0.6. In some examples, x is 0.15 to 0.7, B is Ga, a is 0.05 to 0.8, y is 0.05 to 0.30, C is Ca, b is 0.05 to 0.25, z is 0.50 to 1, D is Ta, and c is 0.4 to 0.6. In some examples, x is 0.15 to 0.7, B is Al, a is 0.05 to 0.15, y is 0.05 to 0.30, C is Ba, b is 0.05 to 0.10, z is 0.50 to 1, D is Ta, and e is 0.4 to 0.6. In some examples, x is 0.15 to 0.7, B is Ga, a is 0.05 to 0.8, y is 0.05 to 0.30, C is Ba, b is 0.05 to 0.10, z is 0.50 to 1, D is Ta, and e is 0.4 to 0.6. In some examples, x is 0.15 to 0.7, B is Al, a is 0.05 to 0.15, y is 0.05 to 0.30, C is Sr, b is 0.25 to 0.30, z is 0.50 to 1, D is Ta, and c is 0.4 to 0.6. In some examples, x is 0.15 to 0.7, B is Ga, a is 0.05 to 0.8, y is 0.05 to 0.30, C is Sr, b is 0.25 to 0.30, z is 0.50 to 1, D is Ta, and e is 0.4 to 0.6. In some examples, x is 0.15 to 0.7, B is Al, a is 0.05 to 0.15, y is 0.05 to 0.30, C is Mg, b is 0.22 to 0.28, z is 0.50 to 1, D is Ta, and c is 0.4 to 0.6. And, in some examples, x is 0.15 to 0.7, B is Ga, a is 0.05 to 0.8, y is 0.05 to 0.30, C is Mg, b is 0.22 to 0.28, z is 0.50 to 1, D is Ta, and c is 0.4 to 0.6.

In some embodiments, D is Nb, and c is 0.2 to 0.4. For example, x is 0.15 to 0.7, B is Al, a is 0.05 to 0.15, y is 0.05 to 0.30, C is Ca, b is 0.05 to 0.25, z is 0.50 to 1, D is Nb, and e is 0.2 to 0.4. In some examples, x is 0.15 to 0.7, B is Ga, a is 0.05 to 0.8, y is 0.05 to 0.30, C is Ca, b is 0.05 to 0.25, z is 0.50 to 1, D is Nb, and e is 0.2 to 0.4. In some examples, x is 0.15 to 0.7, B is Al, a is 0.05 to 0.15, y is 0.05 to 0.30, C is Ba, b is 0.05 to 0.10, z is 0.50 to 1, D is Nb, and c is 0.2 to 0.4. In some examples, x is 0.15 to 0.7, B is Ga, a is 0.05 to 0.8, y is 0.05 to 0.30, C is Ba, b is 0.05 to 0.10, z is 0.50 to 1, D is Nb, and c is 0.2 to 0.4. In some examples, x is 0.15 to 0.7, B is Al, a is 0.05 to 0.15, y is 0.05 to 0.30, C is Sr, b is 0.25 to 0.30, z is 0.50 to 1, D is Nb, and c is 0.2 to 0.4. In some examples, x is 0.15 to 0.7, B is Ga, a is 0.05 to 0.8, y is 0.05 to 0.30, C is Sr, b is 0.25 to 0.30, z is 0.50 to 1, D is Nb, and c is 0.2 to 0.4. In some examples, x is 0.15 to 0.7, B is Al, a is 0.05 to 0.15, y is 0.05 to 0.30, C is Mg, b is 0.22 to 0.28, z is 0.50 to 1, D is Nb, and c is 0.2 to 0.4. And, in some examples, x is 0.15 to 0.7, B is Ga, a is 0.05 to 0.8, y is 0.05 to 0.30, C is Mg, b is 0.22 to 0.28, z is 0.50 to 1, D is Nb, and cis 0.2 to 0.4.

In some embodiments, D is Ti, and c is 0.8 to 1.0. For example, x is 0.15 to 0.7, B is Al, a is 0.05 to 0.15, y is 0.05 to 0.30, C is Ca, b is 0.05 to 0.25, z is 0.50 to 1, D is Ti, and c is 0.8 to 1.0. In some examples, x is 0.15 to 0.7, B is Ga, a is 0.05 to 0.8, y is 0.05 to 0.30, C is Ca, b is 0.05 to 0.25, z is 0.50 to 1, D is Ti, and c is 0.8 to 1.0. In some examples, x is 0.15 to 0.7, B is Al, a is 0.05 to 0.15, y is 0.05 to 0.30, C is Ba, b is 0.05 to 0.10, z is 0.50 to 1, D is Ti, and c is 0.8 to 1.0. In some examples, x is 0.15 to 0.7, B is Ga, a is 0.05 to 0.8, y is 0.05 to 0.30, C is Ba, b is 0.05 to 0.10, z is 0.50 to 1, D is Ti, and c is 0.8 to 1.0. In some examples, x is 0.15 to 0.7, B is Al, a is 0.05 to 0.15, y is 0.05 to 0.30, C is Sr, b is 0.25 to 0.30, z is 0.50 to 1, D is Ti, and c is 0.8 to 1.0. In some examples, x is 0.15 to 0.7, B is Ga, a is 0.05 to 0.8, y is 0.05 to 0.30, C is Sr, b is 0.25 to 0.30, z is 0.50 to 1, D is Ti, and c is 0.8 to 1.0. In some examples, x is 0.15 to 0.7, B is Al, a is 0.05 to 0.15, y is 0.05 to 0.30, C is Mg, b is 0.22 to 0.28, z is 0.50 to 1, D is Ti, and c is 0.8 to 1.0. And, in some examples, x is 0.15 to 0.7, B is Ga, a is 0.05 to 0.8, y is 0.05 to 0.30, C is Mg, b is 0.22 to 0.28, z is 0.50 to 1, D is Ti, and c is 0.8 to 1.0.

In some embodiments, D is W, and c is 0.2 to 0.4. For example, x is 0.15 to 0.7, B is Al, a is 0.05 to 0.15, y is 0.05 to 0.30, C is Ca, b is 0.05 to 0.25, z is 0.50 to 1, D is W, and c is 0.2 to 0.4. In some examples, x is 0.15 to 0.7, B is Ga, a is 0.05 to 0.8, y is 0.05 to 0.30, C is Ca, b is 0.05 to 0.25, z is 0.50 to 1, D is W, and c is 0.2 to 0.4. In some examples, x is 0.15 to 0.7, B is Al, a is 0.05 to 0.15, y is 0.05 to 0.30, C is Ba, b is 0.05 to 0.10, z is 0.50 to 1, D is W, and c is 0.2 to 0.4. In some examples, x is 0.15 to 0.7, B is Ga, a is 0.05 to 0.8, y is 0.05 to 0.30, C is Ba, b is 0.05 to 0.10, z is 0.50 to 1, D is W, and c is 0.2 to 0.4. In some examples, x is 0.15 to 0.7, B is Al, a is 0.05 to 0.15, y is 0.05 to 0.30, C is Sr, b is 0.25 to 0.30, z is 0.50 to 1, D is W, and c is 0.2 to 0.4. In some examples, x is 0.15 to 0.7, B is Ga, a is 0.05 to 0.8, y is 0.05 to 0.30, C is Sr, b is 0.25 to 0.30, z is 0.50 to 1, D is W, and c is 0.2 to 0.4. In some examples, x is 0.15 to 0.7, B is Al, a is 0.05 to 0.15, y is 0.05 to 0.30, C is Mg, b is 0.22 to 0.28, z is 0.50 to 1, D is W, and e is 0.2 to 0.4. And, in some examples, x is 0.15 to 0.7, B is Ga, a is 0.05 to 0.8, y is 0.05 to 0.30, C is Mg, b is 0.22 to 0.28, z is 0.50 to 1, D is W, and c is 0.2 to 0.4.

Examples compositions of Formula (V) are set forth in Table 2.

TABLE 2
Examples of compositions of Formula (V).

| Example | Li | B | La | C | Zr | D | O |
|---|---|---|---|---|---|---|---|
| T2-1 | 6.40 | Al-0.05 | 2.95 | Ca-0.05 | 1.50 | Ta-0.50 | 12 |
| T2-2 | 6.75 | — | 2.75 | Ca-0.25 | 1.50 | Ta-0.50 | 12 |
| T2-3 | 6.30 | Ga-0.15 | 2.95 | Ba-0.05 | 1.70 | Nb-0.30 | 12 |
| T2-4 | 6.85 | Al-0.15 | 2.70 | Sr-0.30 | 1.00 | Ti-1.00 | 12 |
| T2-5 | 6.30 | Ga-0.08 | 2.76 | Mg-0.24 | 1.65 | W-0.35 | 12 |

In some embodiments, the LLZO material is substantially a cubic garnet phase. As used herein, the term “substantially a cubic phase” refers to a LLZO material comprising at least about 80%, at least about 85%, at least about 90%, at least about 95%, at least about 96%, at least about 97%, at least about 98%, or at least about 99% of a cubic phase.

In some embodiments, the LLZO material is substantially a tetragonal garnet phase. As used herein, the term “substantially a tetragonal phase” refers to a LLZO material comprising at least about 80%, at least about 85%, at least about 90%, at least about 95%, at least about 96%, at least about 97%, at least about 98%, or at least about 99% of a tetragonal phase.

In some embodiments, the LLZO material is substantially a tetragonal and/or cubic garnet phase (i.e., the LLZO material comprises at least about 80%, at least about 85%, at least about 90%, at least about 95%, at least about 96%, at least about 97%, at least about 98%, or at least about 99% of a tetragonal phase and/or a cubic phase). In other words, both a tetragonal phase and a cubic phase may be present in the LLZO material.

In some embodiments, the LLZO material is substantially free of a secondary phase. As used herein, the term “substantially free of a secondary phase” refers to a LLZO material comprising less than about 20%, less than about 15%, less than about 10%, less than about 5%, less than about 4%, less than about 3%, less than about 2%, or less than about 1% of a secondary phase. In some embodiments, the solid-state electrolyte material is free of a secondary phase. Exemplary secondary phases comprise, by way of non-limiting example, LiHLZO (i.e., Li₇₋ₓHₓLZO), Li₂CO₃, LiOH, Li₂O, La₂Zr₂O₇, La₂O₃, ZrO₂, Li₂ZrO₃, Li₆Zr₂O₇, Li₈ZrO₆, LiAlO₂, or any combination thereof.

In some embodiments, the LLZO material has a D90 particle size of less than about 50 μm. For example, the LLZO material may have a D90 particle size of less than about 25 μm. In some embodiments, the LLZO material has a D90 particle size of less than about 10 μm. In other embodiments, the LLZO material has a D90 particle size of less than about 7.5 μm. In some embodiments, the LLZO material has a D90 particles of less than about 5 μm. In some embodiments, the LLZO material has a D90 particle size of less than about 2.5 μm. In some embodiments, the LLZO material has a D90 particle size of less than about 1.5 μm. In other embodiments, the LLZO material has a D90 particle size of less than about 1.0 μm. In some embodiments, the LLZO material has a D90 particle size of less than about 0.5 μm. And, in some embodiments, the LLZO material has a D90 particle size of less than about 0.3 μm.

In some embodiments, the LLZO material is present in the green body in an amount of from about 5% to about 80% by volume based on the total volume of the green body. In other embodiments, the LLZO material is present in the green body in an amount of from about 15% to about 70% by volume based on the total volume of the green body. And, in some embodiments, the LLZO material is present in the green body in an amount of from about 20% to about 60% by volume based on the total volume of the green body.

### B. Binder

The binder is a material that facilitates adhesion of another material (e.g., the LLZO material) and is removable from the green body via debinding and/or sintering.

In some embodiments, the binder is a cured binder. In some embodiments, the cured binder comprises a cross-linked polymer material. The cross-linked polymer material is formed from at least one polymer comprising a cross-linkable moiety, or any combination thereof. For example, the cross-linkable moiety of the at least one polymer may be a vinyl moiety, a carbonyl moiety, a thiocarbonyl moiety, an epoxide moiety, a hydroxyl moiety, or any combination thereof.

In some embodiments, the cross-linked polymer material comprises a polysiloxane, polyurethane, a polythioester, a polyacrylate, a vinyl polymer, a polyisoprene, or any combination thereof. In some embodiments, the cross-linked polymer material comprises a polysiloxane. In some embodiments, the cross-linked polymer material comprises a polyurethane. In some embodiments, the polymer material comprises a polythioester. In other embodiments, the cross-linked polymer material comprises a polyacrylate. In some embodiments, the cross-linked polymer material comprises a vinyl polymer. And, in some embodiments, the cross-linked polymer material comprises polyisoprene.

As used herein, the term “vinyl polymer” refers to a polymer that is derived from vinyl (e.g., substituted vinyl) monomers. Examples of suitable vinyl polymers include polyethylene, polypropylene, polystyrene, polyvinyl chloride (PVC), polyvinyl acetate (PVAc), polyacrylonitrile, polyvinyl butyral (PVB), or any combination thereof.

In some embodiments, the cured binder is cured by exposure to a radiation. For example, the cured binder is cured by exposure to ultraviolet (UV) radiation. In other embodiments, the cured binder is cured by heating (i.e., thermal curing). In other embodiments, the binder is cured by addition of a hardener or cross-linker.

In some embodiments, the binder is not a cured binder, i.e., the binder is an uncured binder. For example, the binder comprises a polysiloxane, polyurethane, a polythioester, a polyacrylate, a vinyl polymer, a polyisoprene, or any combination thereof, wherein the binder is not substantially cross-linked.

In some embodiments, the binder is present in the green body in an amount of from about 20% to about 95% by volume based on the total volume of the green body. In other embodiments, the binder is present in the green body in an amount of from about 30% to about 85% by volume based on the total volume of the green body. And, in some embodiments, the binder is present in the green body in an amount of from about 40% to about 80% by volume based on the total volume of the green body.

### C. Photoinitiator/Decomposed Photoinitiator

In some embodiments, the green body further comprises a photoinitiator, a decomposed photoinitiator, or any combination thereof. When present, the photoinitiator and/or the decomposed photoinitiator is removable from the green body via debinding and/or sintering.

The photoinitiator may be any photoinitiator suitable for initiating cross-linking. For example, the photoinitiator may comprise 2,2-dimethoxy-1,2-diphenylethan-1-one, maleimides, 2-hydroxy-2-methyl-1-phenylpropanone, 1-hydroxy-cyclohexylphenylketone, oligo(2-hydroxy-2-methyl-1-[4-(1-methylvinyl)phenyl]propanone, 2-hydroxy-2-methyl-1-phenylpropan-1-one, benzophenone, 4-Phenylbenzophenone, bis[4-(dimethylamino)phenyl]methanone, methylbenzophenone, 4,4′-Bis(diethyl amino)benzophenone, 4-(2-hydroxyethoxy)phenyl-(2-hydroxy-2-methylpropyl)ketone, hydroxyacetophenone, isopropyl thioxanthone, 2,4,5-trimethylbenzoly-diphenyl phosphine oxides, bis(2,6-dimethyloxybenzoyl) 2,4,4-trimethylpentyl)phosphine oxide, bis(2,4,6-trimethylbenzoyl)-phenylphosphineoxide, benzyldimethyl ketal, camphorquinone, 2-hydroxy-2-methyl-1-(4-t-butyl)phenylpropan-1-none, bis(2,4,6-trimethylbenzoyl), 2-benzyl-2-N,N-dimethylamino-1-(4-morpholinophenyl)-1 butanone, 2-mercaptobenzoxazole, 2-methyl-1-[4-(methylthiophenyl)-2-morpholinopropanone, 2-ethylhexyl-(4-N,N-dimethyl amino)benzoate, ethyl-4-(dimethylamino)benzoate, a polymeric photoinitiator thereof, or any combination thereof. In some embodiments, the photoinitiator comprises, 2,2-dimethoxy-1,2-diphenylethan-1-one, 2-hydroxy-2-methyl-1-phenylpropanone, 1-hydroxy-cyclohexylphenylketone, benzophenone, 4-Phenylbenzophenone, bis[4-(dimethylamino)phenyl]methanone, methylbenzophenone, 4,4′-Bis(diethyl amino)benzophenone, 4-(2-hydroxyethoxy)phenyl-(2-hydroxy-2-methylpropyl)ketone, hydroxyacetophenone, isopropyl thioxanthone, a polymeric photoinitiator thereof, or any combination thereof. In other embodiments, the photoinitiator comprises benzyldimethyl ketal, camphorquinone, 2-hydroxy-2-methyl-1-(4-t-butyl)phenylpropan-1-none, bis(2,4,6-trimethylbenzoyl), 2-benzyl-2-N,N-dimethylamino-1-(4-morpholinophenyl)-1 butanone, 2-mercaptobenzoxazole, 2-methyl-1-[4-(methylthiophenyl)-2-morpholinopropanone, 2-ethylhexyl-(4-N,N-dimethyl amino)benzoate, ethyl-4-(dimethylamino)benzoate, a polymeric photoinitiator thereof, or any combination thereof.

The decomposed photoinitiator may be any unreactive species resulting from any photoinitiator described herein.

In some embodiments, the photoinitiator is present in the green body in an amount of less than about 3%, less than about 2.5%, less than about 2%, less than about 1%, less than about 0.5%, less than about 0.25%, less than about 0.1%, less than about 0.01%, or less than about 0.0010% by weight based on the total weight of the green body.

In some embodiments, the decomposed photoinitiator is present in the green body in an amount of less than about 3%, less than about 2.5%, less than about 2%, less than about 1%, less than about 0.5%, less than about 0.25%, less than about 0.1%, less than about 0.01%, or less than about 0.0010% by weight based on the total weight of the green body.

### D. Optional Solvent/Dispersant(s)

In some embodiments, the green body optionally comprises a solvent. The solvent may be used facilitate processing and/or handling during formation of the green body. When present, the solvent is removable from the green body via debinding and/or sintering.

In some embodiments, the solvent is substantially unreactive towards the LLZO material. As used herein, the term “substantially unreactive towards the LLZO material” refers to a solvent that is aprotic or that is otherwise unreactive towards the LLZO material. For example, the solvent may be substantially unreactive towards the LLZO material such that no LiHLZO is formed, or LiHLZO is only formed in limited amounts after exposure to the solvent (i.e., the LLZO material comprises less than about 20%, less than about 10%, less than about 7.5%, less than about 5%, less than about 4%, less than about 3%, less than about 2%, or less than about 1% LiHLZO after exposure to the solvent).

In some embodiments, the solvent is free of water, ethanol, isopropanol, methanol, terpineol, acetic acid, formic acid.

In some embodiments, the solvent has a pKₐ of at least about 12, at least about 13, at least about 14, at least about 15, at least about 16, at least about 17, at least about 18, at least about 19, at least about 20, at least about 21, or at least about 22.

In some embodiments, the solvent comprises an aprotic solvent (e.g., a polar aprotic solvent or a non-polar aprotic solvent). The aprotic solvent may be substantially unreactive towards the LLZO material. For example, the aprotic solvent may comprise acetone, acetonitrile, dichloromethane, diisopropylamine, triethylamine, dimethyl sulfoxide, dimethyl sulfone, ethyl acetate, pyridine, tetrahydrofuran, pentane, hexane, diethyl ether, benzene, toluene, or any combination thereof.

In some embodiments, the solvent is present in the green body in an amount of less than about 2%, less than about 1%, less than about 0.5%, less than about 0.25%, less than about 0.1%, less than about 0.01%, or less than about 0.001% by weight based on the total weight of the green body.

In some embodiments, the green body optionally comprises a dispersant. Dispersants useful in green bodies of the present invention are substantially inert in the presence of the LLZO material and/or the binder. In some embodiments, the green body (cured and/or uncured) and/or binder mixture comprise a dispersant, wherein the dispersant comprises a fish oil, a fatty acid ester, sulfonated fatty acid, or any combination thereof.

In some embodiments, the green body comprises less than 10 wt % (e.g., less than 5 wt %, less than 3 wt %, less than 1 wt %, or less than 0.5 wt %) of a dispersant by weight of the green body. In some embodiments, the dispersant has a pH of greater than about 8.

### E. Pore Forming Agent

In some embodiments, the green body further comprises a pore forming agent. When present, the pore forming agent is removable via debinding and/or sintering and facilitates the formation of pores in the sintered body. The pore forming agent may be any material suitable for forming pores during debinding and/or sintering.

For example, the pore forming agent may comprise a polymer, carbon spheres, carbon tubes, starches, or any combination thereof. In some embodiments, the pore forming agent comprises a polymer. For example, the polymer may comprise polypropylene, polyethylene, polymethylpentene, polybutene-1, ethylene-octene copolymers, propylene-butane copolymers, polyisobutylene, poly(α-olefin), ethylene propylene rubber, ethylene propylene diene monomer rubber, ethylene-vinyl acetate, ethylene-acrylate copolymers, polyamides, polyesters, polyurethanes, styrene block copolymers, polycaprolactone, polyimide, polyvinyl chloride, polycarbonates, polyacrylates, polymethacrylates, fluoropolymers, epoxy resins, epoxy polymers, silicone rubber, styrenes, acrylonitrile butadiene styrene (ABS), or any combination thereof.

In some embodiments, the pore forming agent comprises carbon spheres. In other embodiments, the pore forming agent comprises carbon tubes. And, in some embodiments, the pore forming agent comprises starches.

In some embodiments, the pore forming agent is present in the green body in an amount of from about 0% to about 80% by volume based on the total volume of the green body. In other embodiments, the pore forming agent is present in the green body in an amount of from about 10% to about 70% by volume based on the total volume of the green body. And, in some embodiments, the pore forming agent is present in the green body in an amount of from about 15% to about 60% by volume based on the total volume of the green body.

In some embodiments, the green body has a thickness of from about 500 nm to about 1000 μm. In some embodiments, the green body has a thickness of from about 1 μm to about 100 μm. In other embodiments, the green body has a thickness of from about 1 μm to about 75 μm. In some embodiments, the green body has a thickness of from about 1 μm to about 50 μm. In some embodiments, the green body has a thickness of from about 1 μm to about 25 μm. In other embodiments, the green body has a thickness of from about 1 μm to about 80 μm. In some embodiments, the green body has a thickness of from about 20 μm to about 80 μm. In some embodiments, the green body has a thickness of from about 20 μm to about 60 μm. In some embodiments, the green body has a thickness of from about 100 μm to about 200 μm. In some embodiments, the green body has a thickness of from about 150 μm to about 300 μm. In some embodiments, the green body has a thickness of from about 250 μm to about 500 μm. In some embodiments, the green body has a thickness of from about 350 μm to about 500 μm. In some embodiments, the green body has a thickness of from about 500 μm to about 750 μm. In some embodiments, the green body has a thickness of from about 750 μm to about 1000 μm.

### F. Bilayer Green Body

In some embodiments, the green body further comprises a first layer and a second layer at least partially disposed on the first layer. In such embodiments, the LLZO material is further defined as a first LLZO material and the binder is further defined as a first binder. The first layer comprises the first LLZO material and the first binder. The second layer comprises a second LLZO material and a second binder.

The first LLZO material may be any LLZO material described herein. The second LLZO material may be any LLZO material described herein. In some embodiments, the first and second LLZO materials are the same. And, in other embodiments, the first and second LLZO materials are different.

The first binder may be any binder described herein. The second binder may be any binder described herein. In some embodiments, the first and second binders are the same. And, in other embodiments, the first and second binders are different.

In some embodiments, the second layer further comprises a pore forming agent. The pore forming agent may be any pore forming agent described herein. For example, the pore forming agent may comprise a polymer, carbon spheres, carbon tubes, starches, or any combination thereof.

In some embodiments, the first layer is substantially free of a pore forming agent (e.g., the first layer comprises less than about 10%, less than about 5%, less than about 2.5%, less than about 1%, less than about 0.1%, less than about 0.01%, or less than about 0.001% of the pore-forming agent by weight of the first layer). In other embodiments, the first layer is free of a pore forming agent.

### G. Percent Density

In some embodiments, the green body has a percent density of at least about 87.5%. In other embodiments, the green body has a percent density of at least about 90%. In some embodiments, the green body has a percent density of at least about 92.5%. In some embodiments, the green body has a percent density of at least about 95%. In some embodiments, the green body has a percent density of at least about 96%. In some embodiments, the green body has a percent density of at least about 97%. In other embodiments, the green body has a percent density of at least about 97.5%. In some embodiments, the green body has a percent density of at least about 98%. In some embodiments, the green body has a percent density of at least about 98.5%. In some embodiments, the green body has a percent density of at least about 99%. And, in some embodiments, the green body has a percent density of at least about 99.5%.

Without wishing to be bound by theory, it is believed that the green body (e.g., the SSE green body) described herein has reduced impurities and/or secondary phases (e.g., LiHLZO content) as compared to conventional green bodies. These reduced impurities and/or secondary phases (e.g., LiHLZO content) result in a green body with a higher percent density as compared to conventional green bodies. Moreover, this increased percent density advantageously allows for greater control and predictability over the sintered products (e.g., SSE separator layers, bilayers, etc.), including the uniformity and dimensions of such products, due to the reduced shrinkage associated with a higher percent density.

### H. Shrinkage

In some embodiments, the green body exhibits an areal shrinkage of less than about 60% when sintered. In some embodiments, the green body exhibits an areal shrinkage of less than about 57.5% when sintered. In other embodiments, the green body exhibits an areal shrinkage of less than about 55% when sintered. In some embodiments, the green body exhibits an areal shrinkage of less than about 52.5% when sintered. In some embodiments, the green body exhibits an areal shrinkage of less than about 50% when sintered. In some embodiments, the green body exhibits an areal shrinkage of less than about 47.5% when sintered. In some embodiments, the green body exhibits an areal shrinkage of less than about 45% when sintered. In some embodiments, the green body exhibits an areal shrinkage of less than about 42.5% when sintered. In some embodiments, the green body exhibits an areal shrinkage of less than about 40% when sintered. In some embodiments, the green body exhibits an areal shrinkage of less than about 37.5% when sintered. In some embodiments, the green body exhibits an areal shrinkage of less than about 35% when sintered. In some embodiments, the green body exhibits an areal shrinkage of less than about 32.5% when sintered. In some embodiments, the green body exhibits an areal shrinkage of less than about 30% when sintered. In some embodiments, the green body exhibits an areal shrinkage of less than about 27.5% when sintered. In some embodiments, the green body exhibits an areal shrinkage of less than about 25% when sintered. In some embodiments, the green body exhibits an areal shrinkage of less than about 22.5% when sintered. And, in some embodiments, the green body exhibits an areal shrinkage of less than about 20% when sintered.

In some embodiments, the green body exhibits a volumetric shrinkage of less than about 70% when sintered. In other embodiments, the green body exhibits a volumetric shrinkage of less than about 67.5% when sintered. In some embodiments, the green body exhibits a volumetric shrinkage of less than about 65% when sintered. In some embodiments, the green body exhibits a volumetric shrinkage of less than about 62.5% when sintered. In other embodiments, the green body exhibits a volumetric shrinkage of less than about 60% when sintered. In some embodiments, the green body exhibits a volumetric shrinkage of less than about 57.5% when sintered. In some embodiments, the green body exhibits a volumetric shrinkage of less than about 55% when sintered. In some embodiments, the green body exhibits a volumetric shrinkage of less than about 52.5% when sintered. In some embodiments, the green body exhibits a volumetric shrinkage of less than about 50% when sintered. In some embodiments, the green body exhibits a volumetric shrinkage of less than about 47.5% when sintered. In some embodiments, the green body exhibits a volumetric shrinkage of less than about 45% when sintered. In some embodiments, the green body exhibits a volumetric shrinkage of less than about 42.5% when sintered. In some embodiments, the green body exhibits a volumetric shrinkage of less than about 40% when sintered. In some embodiments, the green body exhibits a volumetric shrinkage of less than about 37.5% when sintered. In some embodiments, the green body exhibits a volumetric shrinkage of less than about 35% when sintered. In some embodiments, the green body exhibits a volumetric shrinkage of less than about 32.5% when sintered. And, in some embodiments, the green body exhibits a volumetric shrinkage of less than about 30% when sintered.

Without wishing to be bound by theory, it is believed that the green body (e.g., the SSE green body) described herein has reduced impurities and/or secondary phases (e.g., LiHLZO content) as compared to conventional green bodies. These reduced impurities and/or secondary phases (e.g., LiHLZO content) result in a reduced areal shrinkage and/or volumetric shrinkage as compared to conventional green bodies (assuming the same debinding and sintering conditions), since a greater mass loss and change in density is associated with a higher impurities and/or secondary phases (e.g., LiHLZO content). Moreover, this reduction in areal shrinkage and/or volumetric shrinkage advantageously allows for greater control and predictability over the sintered products (e.g., SSE separator layers, bilayers, etc.), including the uniformity and dimensions of such products.

### I. XRPD Pattern

In some embodiments, the LLZO material of the green body (e.g., the SSE green body) has an X-ray powder diffraction pattern characterized by one or more peaks corresponding to 2-theta values measured in degrees that are within t 1.00 degrees of a corresponding peak of a substantially pure sample of the LLZO material. In other embodiments, the LLZO material of the green body has an X-ray powder diffraction pattern characterized by one or more peaks corresponding to 2-theta values measured in degrees that are within +0.90 degrees of a corresponding peak of a substantially pure sample of the LLZO material. In some embodiments, the LLZO material of the green body has an X-ray powder diffraction pattern characterized by one or more peaks corresponding to 2-theta values measured in degrees that are within ±0.80 degrees of a corresponding peak of a substantially pure sample of the LLZO material. In some embodiments, the LLZO material of the green body has an X-ray powder diffraction pattern characterized by one or more peaks corresponding to 2-theta values measured in degrees that are within±0.70 degrees of a corresponding peak of a substantially pure sample of the LLZO material. In other embodiments, the LLZO material of the green body has an X-ray powder diffraction pattern characterized by one or more peaks corresponding to 2-theta values measured in degrees that are within ±0.60 degrees of a corresponding peak of a substantially pure sample of the LLZO material. And, in some embodiments, the LLZO material of the green body has an X-ray powder diffraction pattern characterized by one or more peaks corresponding to 2-theta values measured in degrees that are within ±0.50 degrees of a corresponding peak of a substantially pure sample of the LLZO material.

In some embodiments, the substantially pure sample of the LLZO material is a sample of LLZO material immediately after its synthesis (e.g., calcination).

Without wishing to be bound by theory, it is believed that the green body (e.g., the SSE green body) described herein has a reduced impurities and/or secondary phases (e.g., LiHLZO content) as compared to conventional green bodies. These reduced impurities and/or secondary phases (e.g., LiHLZO content) result in an XRPD pattern for the LLZO material of the green body wherein one or more characteristic peaks are within a narrower threshold (e.g., ±1.00, ±0.90, ±0.80, ±0.70, ±0.60, or ±0.50 degrees) of a corresponding peak of a substantially pure sample of the LLZO material as compared to a conventional green body. In other words, due to reduced impurities and/or secondary phases, the green body exhibits an XRPD pattern that more closely approximates that of the pure LLZO material as compared to a conventional green body.

In another aspect, the present invention provides a green body for forming a solid-state electrolyte. The green body comprises a LLZO material and a binder. The green body exhibits an areal shrinkage of less than about 60% when sintered.

In one aspect, the present invention provides a SSE green body for forming a solid-state electrolyte. The SSE green body comprises a LLZO material and a cured binder. The SSE green body exhibits an areal shrinkage of less than about 60% when sintered.

In a further aspect, the present invention provides a green body for forming a solid-state electrolyte. The green body comprises a LLZO material and a binder. The LLZO material of the green body has an X-ray powder diffraction pattern characterized by one or more peaks corresponding to 2-theta values measured in degrees that are within ±1.00 degrees of a corresponding peak of a substantially pure sample of the LLZO material.

In one aspect, the present invention provides a SSE green body for forming a solid-state electrolyte. The SSE green body comprises a LLZO material and a cured binder. The LLZO material of the SSE green body has an X-ray powder diffraction pattern characterized by one or more peaks corresponding to 2-theta values measured in degrees that are within ±1.00 degrees of a corresponding peak of a substantially pure sample of the LLZO material.

In one aspect, the present invention provides a green body for forming a solid-state electrolyte. The green body comprises a LLZO material and a binder. The green body has a percent density of at least about 87.5%.

In one aspect, the present invention provides a SSE green body for forming a solid-state electrolyte. The SSE green body comprises a LLZO material and a cured binder. The SSE green body has a percent density of at least about 87.5%.

In yet another aspect, the present invention provides green body for forming a solid-state electrolyte. The green body comprises a LLZO material, a binder, and a photoinitiator, a decomposed photoinitiator, or any combination thereof. In some embodiments, the green body exhibits an areal shrinkage of less than about 60% when sintered. In other embodiments, the LLZO material of the green body has an X-ray powder diffraction pattern characterized by one or more peaks corresponding to 2-theta values measured in degrees that are within +1.00 degrees of a corresponding peak of a substantially pure sample of the LLZO material. And, in some embodiments, the green body has a percent density of at least about 87.5%.

In yet another aspect, the present invention provides SSE green body for forming a solid-state electrolyte. The SSE green body comprises a LLZO material, a cured binder, and a photoinitiator, a decomposed photoinitiator, or any combination thereof. In some embodiments, the SSE green body exhibits an areal shrinkage of less than about 60% when sintered. In other embodiments, the LLZO material of the SSE green body has an X-ray powder diffraction pattern characterized by one or more peaks corresponding to 2-theta values measured in degrees that are within ±1.00 degrees of a corresponding peak of a substantially pure sample of the LLZO material. And, in some embodiments, the SSE green body has a percent density of at least about 87.5%.

### III. METHODS OF FORMING A GREEN BODY

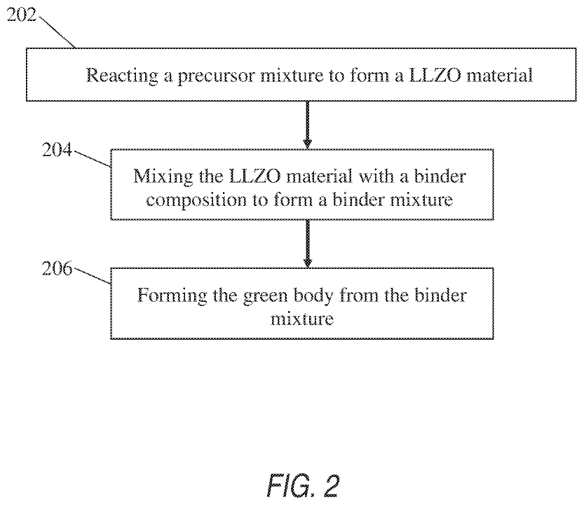

Another aspect of the present invention provides a method of forming a green body for a solid-state electrolyte. With reference to FIG. 2, a flow chart depicting an exemplary implementation of forming a green body for a solid-state electrolyte is provided. The method comprises:
(a) reacting a precursor mixture to form a LLZO material (202);
(b) mixing the LLZO material with a binder composition to form a binder mixture (204); and
(c) forming the green body from the binder mixture (206).

The LLZO material may be any LLZO material described herein. In some implementations, the reacting step (a) further comprises reacting the precursor mixture by calcination to form the LLZO material. For example, the calcination may be performed at a temperature of from about 700 °C to about 1,100 °C. In other implementations, the calcination is performed at a temperature of from about 800 °C to about 1,000 °C. And, in some implementations, the calcination is performed at a temperature of from about 850 °C to about 950 °C.

In other implementations and examples, the reacting step (a) further comprises reacting the precursor mixture by a sol-gel process. In some implementations, the reacting step (a) further comprises reacting the precursor mixture by co-precipitation.

In some implementations, the method further comprises:
(d) dry milling the LLZO material to form a milled LLZO material.

In some implementations, the dry milling step (d) is performed prior to mixing step (b). In some implementations, the dry milling step (d) further comprises
(d1) mixing the LLZO material with a milling additive; and
(d2) dry milling the LLZO material to form a milled LLZO material.

In some implementations, the milling additive comprises a starch, a fatty acid, a fatty acid salt, an active polymeric dispersant, or any combination thereof. For example, the milling additive may comprise a starch. In some implementations, the starch comprises corn starch, potato starch, tapioca starch, arrowroot starch, wheat starch, potato starch, or any combination thereof.

In some implementations and examples, the milling additive comprises a fatty acid. For example, the fatty acid may comprise α-linolenic acid, stearidonic acid, eicosapentaenoic acid, cervonic acid, linoleic acid, linolelaidic acid, γ-linolenic acid, dihomo-γ-linolenic acid, arachidonic acid, docosatetraenoic acid, palmitoleic acid, vaccenic acid, paullinic acid, oleic acid, elaidic acid, gondoic acid, erucic acid, nervonic acid, mead acid, propionic acid, butyric acid, valeric acid, caproic acid, enanthic acid, caprylic acid, pelargonic acid, capric acid, undecylic acid, lauric acid, tridecylic acid, myristic acid, pentadecylic acid, palmitic acid, margaric acid, stearic acid, nonadecylic acid, arachidic acid, heneicosylic acid, behenic acid, tricosylic acid, lignoceric acid, pentacosylic acid, cerotic acid, carboceric acid, montanic acid, nonacosylic acid, melissic acid, hentriacontylic acid, lacceroic acid, psyllic acid, geddic acid, ceroplastic acid, hexatriacontylic acid, heptatriacontylic acid, octatriacontylic acid, nonatriacontylic acid, tetracontylic acid, or any combination thereof. In some implementations, the milling additive comprises a fatty acid salt. For example, the fatty acid salt may comprise a lithium fatty acid salt, a sodium fatty acid salt, a potassium fatty acid salt, an ammonium fatty acid salt, or any combination thereof.

In some implementations, step (d1) is performed prior to step (d2). In other implementations, step (d1) is performed simultaneously with (d2). And, in some implementations, the method further comprises: (d3) removing the milling additive from the milled LLZO material after step (d2).

In some implementations, the dry milling step (d) is performed with a jet mill or an attrition mill. For example, the dry milling step (d) is performed with a jet mill. In other implementations, the dry milling step (d) is performed with an attrition mill.

In some implementations, the LLZO material has a D90 particle size of less than about 50 μm. For example, the LLZO material may have a D90 particle size of less than about 25 μm. In some implementations, the LLZO material has a D90 particle size of less than about 10 μm. In other implementations, the LLZO material has a D90 particle size of less than about 7.5 μm. In some implementations, the LLZO material has a D90 particles of less than about 5 μm. And, in some implementations, the LLZO material has a D90 particle size of less than about 2.5 μm. In some implementations, the LLZO material has a D90 particle size of less than about 1.5 μm. In other implementations, the LLZO material has a D90 particle size of less than about 1.0 μm. In some implementations, the LLZO material has a D90 particle size of less than about 0.5 urm. And, in some implementations, the LLZO material has a D90 particle size of less than about 0.3 μm.

In some implementations, the binder composition comprises a binder. In some implementations, the binder is a cross-linkable polymer material. For example, the cross-linkable polymer material may comprise at least one monomer comprising a cross-linkable moiety, at least one oligomer comprising a cross-linkable moiety, at least one polymer comprising a cross-linkable moiety, or any combination thereof. In some implementations, the cross-linkable moiety of the at least one monomer, the at least one oligomer, and/or the at least one polymer is a vinyl moiety, a carbonyl moiety, a thiocarbonyl moiety, an epoxide moiety, a hydroxyl moiety, an acrylate moiety, or any combination thereof. In some implementations, the cross-linkable moiety is a vinyl moiety. In other implementations, the cross-linkable moiety is a carbonyl moiety. In some implementations, the cross-linkable moiety is a thiocarbonyl moiety. In some implementations, the cross-linkable moiety is an epoxide moiety. In some implementations, the cross-linkable moiety is a hydroxyl moiety. And, in some implementations, the cross-linkable moiety is an acrylate moiety.

In some implementations, the at least one monomer, the at least one oligomer, and/or the at least one polymer comprises a polyurethane, a polythioester, an acrylate, a polyacrylate, a vinyl polymer, a polyisoprene, an epoxy polymer, monomers thereof, oligomers thereof, or any combination thereof.

In some implementations, the binder composition further comprises a photoinitiator. The photoinitiator may be any photoinitiator described herein. For example, the photoinitiator may comprise 2,2-dimethoxy-1,2-diphenylethan-1-one, maleimides, 2-hydroxy-2-methyl-1-phenylpropanone, 1-hydroxy-cyclohexylphenylketone, oligo(2-hydroxy-2-methyl-1-[4-(1-methylvinyl)phenyl]propanone, 2-hydroxy-2-methyl-1-phenylpropan-1-one, benzophenone, 4-Phenylbenzophenone, bis[4-(dimethylamino)phenyl]methanone, methylbenzophenone, 4,4′-Bis(diethyl amino)benzophenone, 4-(2-hydroxyethoxy)phenyl-(2-hydroxy-2-methylpropyl)ketone, hydroxyacetophenone, isopropyl thioxanthone, 2,4,5-trimethylbenzoly-diphenyl phosphine oxides, bis(2,6-dimethyloxybenzoyl) 2,4,4-trimethylpentyl)phosphine oxide, bis(2,4,6-trimethylbenzoyl)-phenylphosphineoxide, benzyldimethyl ketal, camphorquinone, 2-hydroxy-2-methyl-1-(4-t-butyl)phenylpropan-1-none, bis(2,4,6-trimethylbenzoyl), 2-benzyl-2-N,N-dimethylamino-1-(4-morpholinophenyl)-1 butanone, 2-mercaptobenzoxazole, 2-methyl-1-[4-(methylthiophenyl)-2-morpholinopropanone, 2-ethylhexyl-(4-N,N-dimethyl amino)benzoate, ethyl-4-(dimethylamino)benzoate, a polymeric photoinitiator thereof, or any combination thereof.

In some implementations, the binder composition comprises a solvent. The solvent may be any solvent described herein. In some implementations, the solvent is substantially unreactive towards the LLZO material. In some implementations, the solvent has a pKₐ of at least about 12, at least about 13, at least about 14, at least about 15, at least about 16, at least about 17, at least about 18, at least about 19, at least about 20, at least about 21, or at least about 22. In other implementations, the solvent comprises an aprotic solvent (e.g., a polar aprotic solvent or a non-polar aprotic solvent). The aprotic solvent may be substantially unreactive towards the LLZO material. For example, the aprotic solvent may comprise acetone, acetonitrile, dichloromethane, diisopropylamine, triethyl amine, dimethyl sulfoxide, dimethyl sulfone, ethyl acetate, pyridine, tetrahydrofuran, pentane, hexane, diethyl ether, benzene, toluene, or any combination thereof.

In some implementations, the binder composition further comprises a dispersant, a plasticizer, or any combination thereof.

Mixing step (b) may be performed in, for example, an agitator. In some implementations, the mixing step (b) further comprises
(b1) mixing the LLZO material with a binder composition to form a curable SSE mixture; and
(b2) removing agglomerates from the binder mixture.

In some implementations, when the binder composition comprises a solvent, the forming step (c) further comprises removing the solvent of the binder composition to form the green body. In other implementations, the curing step (c) further comprises forming the green body from the binder mixture via spray deposition, fused deposition modeling, screen printing, high-shear compaction, or any combination thereof.

In some implementations, the forming step (c) further comprises:
(c1) forming a curable green body from the binder mixture; and
(c2) curing the curable green body to form the green body.

In some implementations, the forming step (c1) comprises forming a curable green body from the binder mixture via casting (e.g., tapecasting). For example, the binder mixture may be cast onto a substrate thereby forming the curable green body. Exemplary substrates include, by way of non-limiting example, mylar, silicone coated mylar, a metal foil (Ni, Al, Cu, Ti, etc.), polyethylene terephthalate (PET), kapton, polyethylene, polyethylene oxide, or any combination thereof. In some implementations, the casting is performed with a doctor's blade.

In some implementations, the curing step (c2) comprises curing the curable green body with ultraviolet (UV) radiation, heat (i.e., thermal curing), electron beam (e-beam) radiation, or any combination thereof. For example, the curing step (c2) may comprise curing the curable green body with UV radiation. In other implementations, the curing step (c2) comprises curing the curable green body with heat. In some implementations, the curing step (c2) comprises curing the curable green body with e-beam radiation. And, in other implementations, the curing step (c2) comprises the addition of a chemical cross-linker or hardener.

In some implementations, the curing step (c2) further comprises curing the curable green body with UV radiation from a UV lamp to form the green body. In some implementations, the UV lamp emits UV light at a wavelength of from about 10 nm to about 500 nm. In some implementations, the UV lamp emits light at a wavelength of from about 250 nm to about 445 nm. In some implementations, the UV lamp emits light at a wavelength of from about 300 nm to about 445 nm. In some implementations, the UV lamp emits UV light at a wavelength of from about 315 nm to about 400 nm, from about 280 nm to about 314 nm, or from about 100 to about 279 nm. In other implementations, the UV lamp emits UV light at a wavelength of from about 300 nm to about 400 nm, from about 200 nm to about 299 nm, from about 122 to about 200 nm, or from about 10 nm to about 121 nm.

In some implementations, curing step (c2) takes from about 0.1 seconds to about 1 hour. In other implementations, curing step (c2) takes from about 0.1 seconds to about 30 minutes. And, in some implementations, curing step (c2) takes from about 0.1 seconds to about 1 minute.

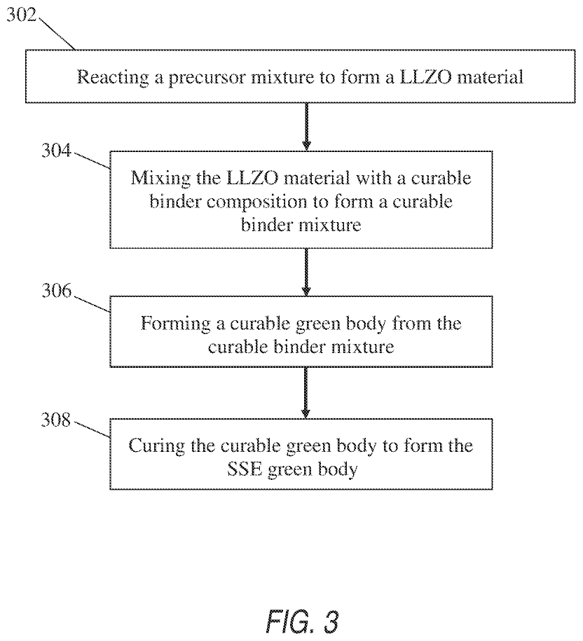

Another aspect of the present invention provides a method of forming a green body for a solid-state electrolyte. With reference to FIG. 3, a flow chart depicting an exemplary implementation of forming a green body for a solid-state electrolyte is provided. The method comprises:
(a-1) reacting a precursor mixture to form a LLZO material, wherein in the precursor mixture comprises
   (i) a lithium-containing compound,
   (ii) a lanthanum-containing compound, and
   (iii) a zirconium-containing compound (302);
(b-1) mixing the LLZO material with a binder composition (e.g., a curable binder composition) to form a curable binder mixture (304);
(c-1) forming a curable green body from the curable binder mixture (306); and
(d-1) curing the curable green body to form the SSE green body (308).

In some implementations, the lithium-containing compound comprises lithium metal, an oxide of lithium, a hydroxide of lithium, a halogen salt of lithium, a carbonate of lithium, a nitrate of lithium, or any combination thereof. For example, the lithium-containing compound may be Li₂O, LiOH, LiOH·H₂O, LiCl, Li₂CO₃, LiNO₃, or any combination thereof. In some implementations, the lithium-containing compound comprises LiO₂. In some implementations, the lithium-containing compound comprises LiOH. In other implementations, the lithium-containing compound comprises LiOH·H₂O. In some implementations, the lithium-containing compound comprises LiCl. In some implementations, the lithium-containing compound comprises Li₂CO₃. And, in some implementations, the lithium-containing compound comprises LiNO₃.

In some implementations, the lanthanum-containing compound comprises lanthanum metal, an oxide of lanthanum, a hydroxide of lanthanum, a halogen salt of lanthanum, a carbonate of lanthanum, a nitrate of lanthanum, or any combination thereof. For example, the lanthanum-containing compound may be La₂O₃, La(OH)₃, LaCl₃, La₂(CO₃)₃, La(NO₃)₃, or any combination thereof. In some implementations, the lanthanum-containing compound comprises La₂O₃. In some implementations, the lanthanum-containing compound comprises La(OH)₃. In other implementations, the lanthanum-containing compound comprises LaCl₃. In some implementations, the lanthanum-containing compound comprises La₂(CO₃)₃. And, in some implementations, the lanthanum-containing compound comprises La(NO₃)₃.

In some implementations, the zirconium-containing compound comprises zirconium metal, an oxide of zirconium, a hydroxide of zirconium, a halogen salt of zirconium, a carbonate of zirconium, a nitrate of zirconium, or any combination thereof. For example, the zirconium-containing compound may be ZrO₂, Zr(OH)₄, ZrCl₄, Zr(OH)₂CO₃ ZrO₂, Zr(NO₃)₄, or any combination thereof. In some implementations, the zirconium-containing compound comprises ZrO₂. In some implementations, the zirconium-containing compound comprises Zr(OH)₄. In other implementations, the zirconium-containing compound comprises ZrCl₄. In some implementations, the zirconium-containing compound comprises Zr(OH)₂CO₃·ZrO₂. And, in some implementations, the zirconium-containing compound comprises Zr(NO₃)₄.

In some implementations, the precursor further comprises (iv) a dopant. For example, the dopant may comprise Be, B, Al, Fe, Zn, Ga, Ge, Na, K, Ca, Rb, Sr, Y, Ag, Ba, Bi, Pr, Nd, Pm, Sm, Gd, Tb, Dy, Ho, Er, Tm, Ce, Mg, Si, Sc, Ti, V, Cr, Mn, Co, Ni, Cu, As, Se, Nb, Mo, Tc, Ru, Rh, Pd, Cd, In, Sn, Sb, Hf, Ta, W, Ir, Pt, Au, Hg, Tl, Pb, Eu, Te, oxides thereof, hydroxides thereof, halogen salts thereof, carbonates thereof, nitrates thereof, or any combination thereof.

The LLZO material may be any LLZO material described herein.

In some implementations, the reacting step (a-1) further comprises reacting the precursor mixture by calcination to form the LLZO material. For example, the calcination may be performed at a temperature of from about 700 °C to about 1,100 °C. In other implementations, the calcination is performed at a temperature of from about 800 °C to about 1,000 °C. And, in some implementations, the calcination is performed at a temperature of from about 850 °C to about 950 °C.

In other implementations and examples, the reacting step (a-1) further comprises reacting the precursor mixture by a sol-gel process. In some implementations, the reacting step (a-1) further comprises reacting the precursor mixture by co-precipitation.

In some implementations, the method further (or optionally) comprises:
(e-1) dry milling the LLZO material to form a milled LLZO material.

In some implementations, the dry milling step (e-1) is performed prior to mixing step (b-1). In some implementations, the dry milling step (e-1) further comprises
(e1-1) mixing the LLZO material with a milling additive; and
(e2-1) dry milling the LLZO material to form a milled LLZO material.

In some implementations, the dry milling step (e-1) further comprises
(e2-1a) dry milling the LLZO material in the absence of a milling additive to form a milled LLZO material.

Additional methods of forming pure-phase, milled LLZO material comprise wet milling in non-reactive media (e.g., non-reactive liquid milling media) with or without the use of a milling additive. Another method of forming pure-phase, milled LLZO material comprises wet milling in a reactive solvent, with or without the use of a milling additive, and subsequently further processing the powder to remove phase impurities while maintaining a desired particle size. In some instances the further processing includes heat treatments under suitable gaseous atmospheres.

In some implementations, the milling additive comprises a starch, a fatty acid, a fatty acid salt, an active polymeric dispersant, or any combination thereof. For example, the milling additive may comprise a starch. In some implementations, the starch comprises corn starch, potato starch, tapioca starch, arrowroot starch, wheat starch, potato starch, or any combination thereof.

In some implementations and examples, the milling additive comprises a fatty acid. For example, the fatty acid may comprise α-linolenic acid, stearidonic acid, eicosapentaenoic acid, cervonic acid, linoleic acid, linolelaidic acid, γ-linolenic acid, dihomo-γ-linolenic acid, arachidonic acid, docosatetraenoic acid, palmitoleic acid, vaccenic acid, paullinic acid, oleic acid, elaidic acid, gondoic acid, erucic acid, nervonic acid, mead acid, propionic acid, butyric acid, valeric acid, caproic acid, enanthic acid, caprylic acid, pelargonic acid, capric acid, undecylic acid, lauric acid, tridecylic acid, myristic acid, pentadecylic acid, palmitic acid, margaric acid, stearic acid, nonadecylic acid, arachidic acid, heneicosylic acid, behenic acid, tricosylic acid, lignoceric acid, pentacosylic acid, cerotic acid, carboceric acid, montanic acid, nonacosylic acid, melissic acid, hentriacontylic acid, lacceroic acid, psyllic acid, geddic acid, ceroplastic acid, hexatriacontylic acid, heptatriacontylic acid, octatriacontylic acid, nonatriacontylic acid, tetracontylic acid, or any combination thereof. In some implementations, the milling additive comprises a fatty acid salt. For example, the fatty acid salt may comprise a lithium fatty acid salt, a sodium fatty acid salt, a potassium fatty acid salt, an ammonium fatty acid salt, or any combination thereof.

In some implementations, wherein the milling of step (e1-1) includes a milling additive, and wherein the milling additive is one or more fatty acids, milling additive is provided at no greater than about 5 wt % (e.g., no greater than about 4 wt %, no greater than about 3 wt %, no greater than about 2 wt %, no greater than about 1 wt %, about 5 wt %, about 4 wt %, about 3 wt %, about 2 wt %, or about 1 wt %) by weight of the LLZO material.

In some implementations, step (e1-1) is performed prior to step (e2-1). In other implementations, step (e1-1) is performed simultaneously with (e2-1). And, in some implementations, the method further comprises:
(e3-1) removing the milling additive from the milled LLZO material after step (e2-1).

In some implementations, the dry milling step (e-1) is performed with a jet mill or an attrition mill. For example, the dry milling step (e-1) is performed with a jet mill. In other implementations, the dry milling step (e-1) is performed with an attrition mill.

In some implementations, the LLZO material has a D90 particle size of less than about 50 μm. For example, the LLZO material may have a D90 particle size of less than about 25 μm. In some implementations, the LLZO material has a D90 particle size of less than about 10 μm. In other implementations, the LLZO material has a D90 particle size of less than about 7.5 μm. In some implementations, the LLZO material has a D90 particles of less than about 5 μm. And, in some implementations, the LLZO material has a D90 particle size of less than about 2.5 μm. In some implementations, the LLZO material has a D90 particle size of less than about 1.5 μm. In other implementations, the LLZO material has a D90 particle size of less than about 1.0 μm. In some implementations, the LLZO material has a D90 particle size of less than about 0.5 μm. And, in some implementations, the LLZO material has a D90 particle size of less than about 0.3 μm.

In some implementations, the curable binder composition comprises (i) at least one monomer, at least one oligomer, or at least one polymer, and (ii) at least one of an initiator and a dispersant, wherein the binder composition forms a cross-linked polymer material. In some examples, the curable binder composition comprises (i) at least one monomer, at least one oligomer, or at least one polymer, and (ii) an initiator (e.g., a photoinitiator). In some examples, the curable binder composition comprises (i) at least one monomer, at least one oligomer, or at least one polymer, (ii) an initiator (e.g., a photoinitiator), and (iii) a dispersant.

In some implementations, the curable binder composition comprises a cross-linkable polymer material. For example, the cross-linkable polymer material may comprise at least one monomer comprising a cross-linkable moiety, at least one oligomer comprising a cross-linkable moiety, at least one polymer comprising a cross-linkable moiety, or any combination thereof. In some implementations, the cross-linkable moiety of the at least one monomer, the at least one oligomer, and/or the at least one polymer is a vinyl moiety, a carbonyl moiety, a thiocarbonyl moiety, an epoxide moiety, a hydroxyl moiety, an acrylate moiety, or any combination thereof. In some implementations, the cross-linkable moiety is a vinyl moiety. In other implementations, the cross-linkable moiety is a carbonyl moiety. In some implementations, the cross-linkable moiety is a thiocarbonyl moiety. In some implementations, the cross-linkable moiety is an epoxide moiety. In some implementations, the cross-linkable moiety is a hydroxyl moiety. And, in some implementations, the cross-linkable moiety is an acrylate moiety.

In some implementations, the at least one monomer, the at least one oligomer, and/or the at least one polymer comprises a polyurethane, a polythioester, an acrylate, a polyacrylate, a vinyl polymer, a polyisoprene, an epoxy polymer, monomers thereof, oligomers thereof, or any combination thereof.

In some implementations, the curable binder composition further comprises a photoinitiator. The photoinitiator may be any photoinitiator described herein. For example, the photoinitiator may comprise 2,2-dimethoxy-1,2-diphenylethan-1-one, maleimides, 2-hydroxy-2-methyl-1-phenylpropanone, 1-hydroxy-cyclohexylphenylketone, oligo(2-hydroxy-2-methyl-1-[4-(1-methylvinyl)phenyl]propanone, 2-hydroxy-2-methyl-1-phenylpropan-1-one, benzophenone, 4-Phenylbenzophenone, bis[4-(dimethylamino)phenyl]methanone, methylbenzophenone, 4,4′-Bis(diethyl amino)benzophenone, 4-(2-hydroxyethoxy)phenyl-(2-hydroxy-2-methylpropyl)ketone, hydroxyacetophenone, isopropyl thioxanthone, 2,4,5-trimethylbenzoly-diphenyl phosphine oxides, bis(2,6-dimethyloxybenzoyl) 2,4,4-trimethylpentyl)phosphine oxide, bis(2,4,6-trimethylbenzoyl)-phenylphosphineoxide, benzyldimethyl ketal, camphorquinone, 2-hydroxy-2-methyl-1-(4-t-butyl)phenylpropan-1-none, bis(2,4,6-trimethylbenzoyl), 2-benzyl-2-N,N-dimethylamino-1-(4-morpholinophenyl)-1 butanone, 2-mercaptobenzoxazole, 2-methyl-1-[4-(methylthiophenyl)-2-morpholinopropanone, 2-ethylhexyl-(4-N,N-dimethyl amino)benzoate, ethyl-4-(dimethylamino)benzoate, a polymeric photoinitiator thereof, or any combination thereof.

For example, the curable binder composition comprises, by way of non-limiting example, Loctite AA 3462, Loctite AA 344, Loctite AA 352, and/or Loctite AA 3951, all of which are commercially available from Henkel Corporation.

In some examples and implementations, the curable binder composition comprises UV-Curable Adhesive LC-3200 which is commercially available from 3M (St. Paul, Minn.).

In other examples, the curable binder composition comprises Permabond UV610, UV620, UV625, UV630, UV632, UV639, UV640, UV645, UV670, UV681, UV683, UV6160, UV6231, and/or UV7141, all of which are commercially available from Permabond Engineering Adhesives.

In some implementations, the curable binder composition further comprises a solvent. The solvent may be any solvent described herein. In some implementations, the solvent is substantially unreactive towards the LLZO material. In some implementations, the solvent has a pKₐ of at least about 12, at least about 13, at least about 14, at least about 15, at least about 16, at least about 17, at least about 18, at least about 19, at least about 20, at least about 21, or at least about 22. In other implementations, the solvent comprises an aprotic solvent (e.g., a polar aprotic solvent or a non-polar aprotic solvent). The aprotic solvent may be substantially unreactive towards the LLZO material. For example, the aprotic solvent may comprise acetone, acetonitrile, dichloromethane, diisopropylamine, triethyl amine, dimethyl sulfoxide, dimethyl sulfone, ethyl acetate, pyridine, tetrahydrofuran, pentane, hexane, diethyl ether, benzene, toluene, or any combination thereof.

In some implementations, the binder composition further comprises a dispersant, a plasticizer, or any combination thereof.

Mixing step (b-1) maybe performed in, for example, an agitator. In some implementations, the mixing step (b-1) further comprises
(b1-1) mixing the LLZO material with an curable binder composition to form a curable SSE mixture; and
(b2-1) removing agglomerates from the curable SSE mixture.

In some implementations, the mixing step (b-1) further comprises
(b3-1) degassing the curable SSE mixture.

In some implementations, the forming step (c-1) comprises forming a curable green body from the curable SSE mixture by casting the curable SSE mixture. For example, the curable SSE mixture may be cast onto a substrate thereby forming the curable green body. Exemplary substrates include, by way of non-limiting example, mylar, silicone coated mylar, a metal foil (Ni, Al, Cu, Ti, etc.), PET, kapton, polyethylene, polyethylene oxide, or any combination thereof. In some implementations, the casting is performed with a doctor's blade.

In some implementations, the curing step (d-1) further comprises curing the curable green body with UV radiation, heat (i.e., thermal curing), e-beam radiation, or any combination thereof to form the SSE green body. For example, the curing step (d-1) may comprise curing the curable green body with UV radiation. In other implementations, the curing step (d-1) comprises curing the curable green body with heat. In some implementations, the curing step (d-1) comprises curing the curable green body with e-beam radiation. And, in other implementations, the curing step (d-1) comprises the addition of a chemical cross-linker or hardener.

In some implementations and examples, the curing step may be performed with UV radiation form a UV lamp. In some implementations, the UV lamp emits UV light at a wavelength of from about 10 nm to about 500 nm. In some implementations, the UV lamp emits light at a wavelength of from about 250 nm to about 445 nm. In some implementations, the UV lamp emits light at a wavelength of from about 300 nm to about 445 nm. In some implementations, the UV lamp emits UV light at a wavelength of from about 315 nm to about 400 nm, from about 280 nm to about 314 nm, or from about 100 to about 279 nm. In other implementations, the UV lamp emits UV light at a wavelength of from about 300 nm to about 400 nm, from about 200 nm to about 299 nm, from about 122 to about 200 nm, or from about 10 nm to about 121 nm.

In some implementations, the curing step (d-1) takes from about 0.1 seconds to about 1 hour. In other implementations, the curing step (d-1) takes from about 0.1 seconds to about 30 minutes. And, in some implementations, the curing step (d-1) takes from about 0.1 seconds to about 1 minute.

In some implementations, the method further comprises repeating steps (c-1) and (d-1) to form a bilayer SSE green body. In such embodiments, a second layer is at least partially disposed on a first layer of the SSE green body. In such implementations, the curable SSE mixture of the second layer may further comprise a pore forming agent. The pore forming agent may be any pore forming agent described herein.

In another aspect, the present invention provides a method of forming a SSE green body for a solid-state electrolyte. The method comprises:
(a-2) reacting a precursor mixture to form a LLZO material, wherein in the precursor mixture comprises
   (i) a lithium-containing compound,
   (ii) a lanthanum-containing compound, and
   (iii) a zirconium-containing compound;
(b-2) dry milling the LLZO material to form a milled LLZO material;
(c-2) mixing the milled LLZO material with an ultraviolet (UV) curable binder composition to form a UV curable mixture;
(d-2) forming a UV curable green body from the UV curable mixture; and
(e-2) curing the UV curable green body to form the SSE green body.

In another aspect, the present invention provides a method of forming a green body for a solid-state electrolyte. The method comprises:
(a-3) providing a LLZO material;
(b-3) mixing the LLZO material with a binder composition to form a binder mixture; and
(c-3) forming the green body from the binder mixture.

In another aspect, the present invention provides a method of forming a SSE green body for a solid-state electrolyte. The method comprises:
(a-4) providing a LLZO material;
(b-4) mixing the LLZO material with a binder composition (e.g., a curable binder composition) to form a curable SSE mixture;
(c-4) forming a curable green body from the curable SSE mixture; and
(d-4) curing the curable green body to form the SSE green body.

In another aspect, the present invention provides a method of forming a SSE green body for a solid-state electrolyte. The method comprises:
(a-5) providing a LLZO material;
(b-5) dry milling the LLZO material to form a milled LLZO material;
(c-5) mixing the milled LLZO material with an ultraviolet (UV) curable binder composition to form a UV curable mixture;
(d-5) forming a UV curable green body from the UV curable mixture; and
(e-5) curing the UV curable green body to form the SSE green body.

Another aspect of the present invention provides a green body for a solid-state electrolyte, wherein the green body is prepared according to any method described herein. In some embodiments, the green body exhibits an areal shrinkage of less than about 60% when sintered. In other embodiments, the material of the green body has an X-ray powder diffraction pattern characterized by one or more peaks corresponding to 2-theta values measured in degrees that are within ±1.00 degrees of a corresponding peak of a substantially pure sample of the material. And, in some embodiments, the green body has a percent density of at least about 87.5%.

A further aspect of the present invention provides a SSE green body for a solid-state electrolyte, wherein the SSE green body is prepared according to a method comprising:
(a-1) reacting a precursor mixture to form a LLZO material, wherein in the precursor mixture comprises
   (i) a lithium-containing compound,
   (ii) a lanthanum-containing compound, and
   (iii) a zirconium-containing compound;
(b-1) mixing the LLZO material with an ultraviolet (UV) curable binder composition to form a UV curable mixture;
(c-1) forming a UV curable green body from the UV curable mixture; and
(d-1) curing the UV curable green body to form the SSE green body;
In some embodiments, the SSE green body exhibits an areal shrinkage of less than about 60% when sintered. In other embodiments, the LLZO material of the SSE green body has an X-ray powder diffraction pattern characterized by one or more peaks corresponding to 2-theta values measured in degrees that are within ±1.00 degrees of a corresponding peak of a substantially pure sample of the LLZO material. And, in some embodiments, the SSE green body has a percent density of at least about 87.5%.

In a further aspect, the present invention provides a SSE green body for a solid-state electrolyte, wherein the SSE green body is prepared according to a method comprising:
(a-2) reacting a precursor mixture to form a LLZO material, wherein in the precursor mixture comprises
   (i) a lithium-containing compound,
   (ii) a lanthanum-containing compound, and
   (iii) a zirconium-containing compound;
(b-2) dry milling the LLZO material to form a milled LLZO material;
(c-2) mixing the milled LLZO material with an ultraviolet (UV) curable binder composition to form a UV curable mixture;
(d-2) forming a UV curable green body from the UV curable mixture; and
(e-2) curing the UV curable green body to form the SSE green body.

In some embodiments, the SSE green body exhibits an areal shrinkage of less than about 60% when sintered. In other embodiments, the LLZO material of the SSE green body has an X-ray powder diffraction pattern characterized by one or more peaks corresponding to 2-theta values measured in degrees that are within ±1.00 degrees of a corresponding peak of a substantially pure sample of the LLZO material. And, in some embodiments, the SSE green body has a percent density of at least about 87.5%.

A further aspect of the present invention provides a SSE green body for a solid-state electrolyte, wherein the SSE green body is prepared according to a method comprising:
(a-4) providing a LLZO material;
(b-4) mixing the LLZO material with a binder composition (e.g., a curable binder composition) to form a curable SSE mixture;
(c-4) forming a curable green body from the curable SSE mixture; and
(d-4) curing the curable green body to form the SSE green body.

In some embodiments, the SSE green body exhibits an areal shrinkage of less than about 60% when sintered. In other embodiments, the LLZO material of the SSE green body has an X-ray powder diffraction pattern characterized by one or more peaks corresponding to 2-theta values measured in degrees that are within t 1.00 degrees of a corresponding peak of a substantially pure sample of the LLZO material. And, in some embodiments, the SSE green body has a percent density of at least about 87.5%.

Another aspect of the present invention provides a SSE green body for a solid-state electrolyte, wherein the SSE green body is prepared according to a method comprising:
(a-5) providing a LLZO material;
(b-5) dry milling the LLZO material to form a milled LLZO material;
(c-5) mixing the milled LLZO material with an ultraviolet (UV) curable binder composition to form a UV curable mixture;
(d-5) forming a UV curable green body from the UV curable mixture; and
(e-5) curing the UV curable green body to form the SSE green body.

In some embodiments, the SSE green body exhibits an areal shrinkage of less than about 60% when sintered. In other embodiments, the LLZO material of the SSE green body has an X-ray powder diffraction pattern characterized by one or more peaks corresponding to 2-theta values measured in degrees that are within t 1.00 degrees of a corresponding peak of a substantially pure sample of the LLZO material. And, in some embodiments, the SSE green body has a percent density of at least about 87.5%.

### VI. EXAMPLES

In order that the invention described herein may be more fully understood, the following examples are set forth. The examples described in this application are offered to illustrate the methods and green bodies provided herein and are not to be construed in any way as limiting their scope.

### Example 1: SSE Green Body

Milling. A doped LLZO powder (260 g) was placed in an attrition mill with zirconia milling media (Inframat Corporation (Manchester, CT); 2.5 kg) and a milling additive (Stearic acid, Sigma Aldrich (St. Louis, MO); 3 g) to improve flowability. After milling, the milled LLZO powder was sieved to remove the zirconia milling media.

Casting and Curing. The milled LLZO powder was mixed with the curable binder composition (a Miltec UV curable binder composition commercially available from Miltec UV (Stevensville, Maryland)) and dispersed with high shear to remove agglomerates and form a UV curable mixture. The UV curable mixture was degassed and then cast with a doctor blade onto a mylar substrate (Tape Casting Warehouse Silicone Coated MYLAR®-07”) to form a UV curable green body. The casting was performed with a TecMaster Coater from Faustel Inc. (Germantown, Wisconsin). The UV curable green body was cured with UV radiation from a UV lamp (MPI-400, Miltec UV (Stevensville, Maryland)) to form the SSE green body.

### Example 2: Comparative SSE Green Body

Milling. The doped LLZO powder (200 g) was placed in a bottle with zirconia milling media and sufficient isopropanol (200 g) to form a fluid mixture. The bottle was then placed on a two-axis mill for wet-milling. The resultant wet-milled mixture was sieved to remove the zirconia milling media and dried to remove the isopropanol.

Casting and Drying. After drying, the resultant wet-milled LLZO powder was dispersed in isopropanol and toluene solvents (menhaden fish oil was the dispersant). Polyvinyl butyral (PVB) binder, benzyl butyl phthalate, and polyalkylene glycol plasticizers were mixed into the dispersion until a uniform slurry was formed. The slurry was degassed and then cast with a doctor blade onto a mylar substrate (Tape Casting Warehouse Silicone Coated MYLAR®-07”). The cast tape was then dried in an oven (30 °C to 50 °C) to remove the solvents and form the comparative SSE green body.

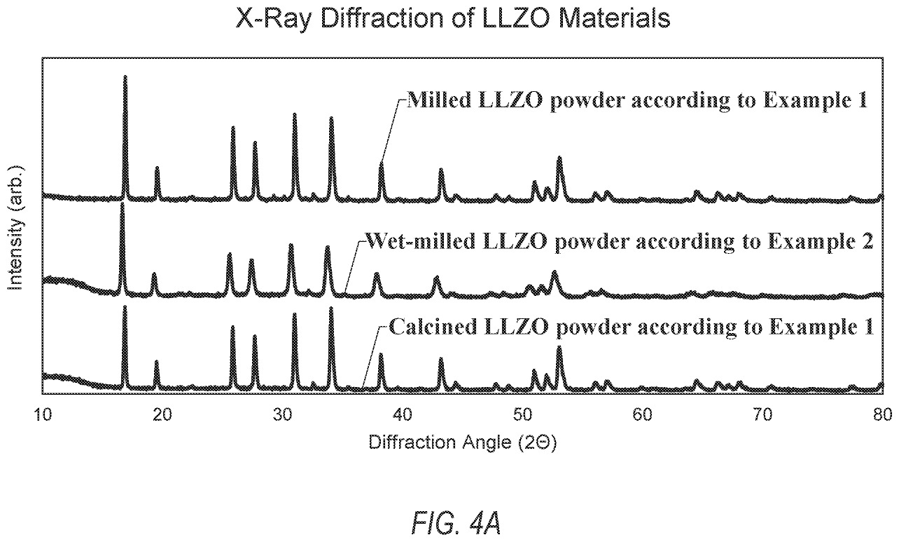

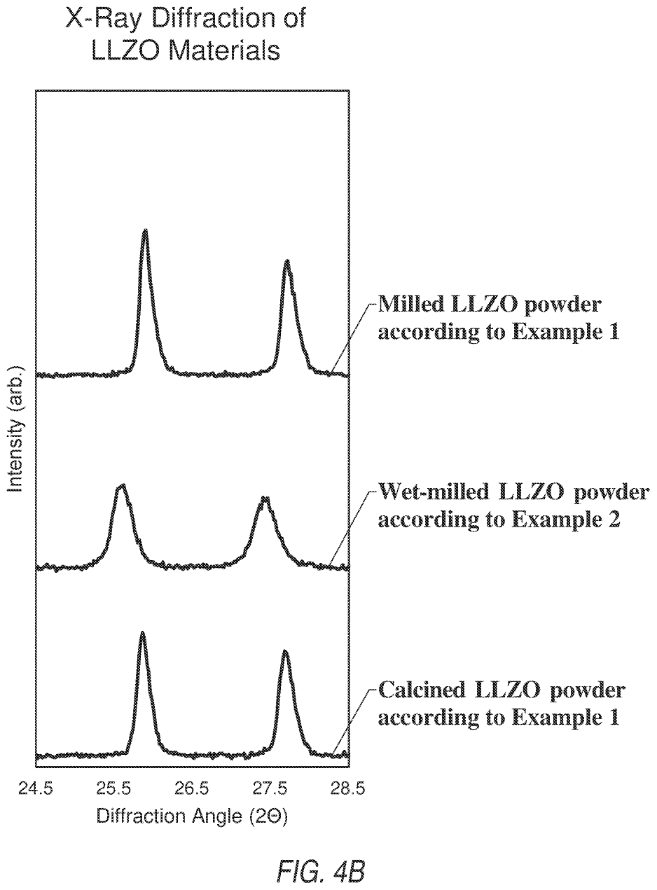

FIG. 4A shows XRPD patterns for a milled LLZO powder prepared according to Example 1, a wet-milled powder according to Example 2, and a calcined LLZO powder (i.e., a reference powder) according to Example 1. The corresponding samples were analyzed on a Bruker D4. As set forth above, the reference powder of Example 1 was used to prepare the wet-milled powder of Example 2. As shown in FIG. 4B, the wet-milled powder of Example 2 is shifted further with respect to the reference powder as compared to the milled powder of Example 1. In other words, the milled LLZO powder of Example 1 exhibits an XRPD pattern more closely aligned with the reference powder as compared to the wet-milled LLZO powder of Example 2.

The shift observed for the wet-milled powder of Example 2 is attributable to the presence of impurities (e.g., LiHLZO) resulting from the use of solvent (i.e., isopropanol) in the wet-milling process of Example 2. In comparison, the milling process of Example 1 did not require a solvent and resulted in a milled powder having fewer impurities than the wet-milled powder of Example 2.

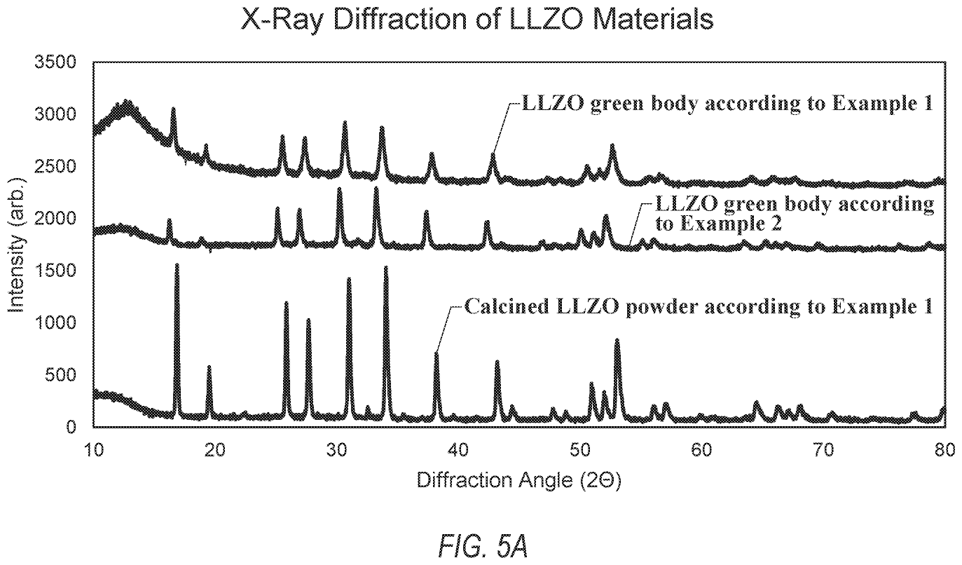

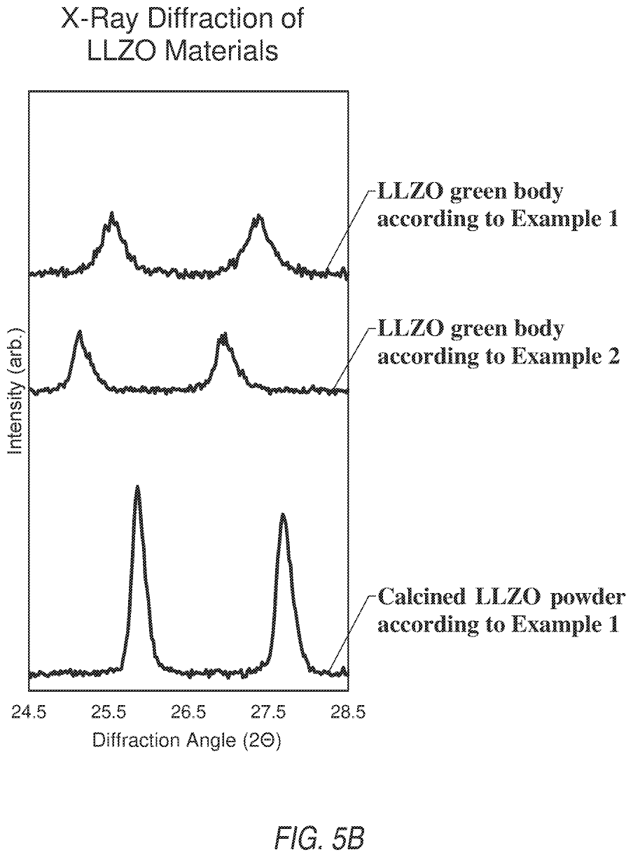

With reference to FIG. 5A, XRPD patterns for a SSE green body prepared according to Example 1, a SSE green body prepared according to Example 2, and a calcined LLZO powder (i.e., a reference powder) prepared according to Example 1 are shown. The corresponding samples were analyzed on a Bruker D4. As set forth above, the reference powder of Example 1 was used to prepare both the SSE green body of Example 1 and the SSE green body of Example 2. As shown in FIG. 5B, the XRPD pattern for the SSE green body of Example 2 is shifted further with respect to the reference powder as compared to the XRPD pattern of the SSE green body of Example 1. In other words, the SSE green body of Example 1 exhibits an XRPD pattern more closely aligned with the reference powder as compared to the SSE green body of Example 2.

The shift observed for the SSE green body of Example 2 is attributable to the presence of impurities (e.g., LiHLZO) resulting from the use of solvent (i.e., isopropanol) both in the wet-milling process and also in the casting step of Example 2. In comparison, the milling, casting, and curing processes of Example 1 did not require a solvent and resulted in a SSE green body having fewer impurities than the SSE green body of Example 2.

The XRPD patterns demonstrate that the implementation of particular processing steps may result in LLZO green bodies having fewer impurities.

The percent density for the materials formed in Examples 1 and 2 are set forth in Table 3. For the percent densities provided in Table 3, the measured densities of each SSE green body were calculated according to ASTM B923-22.

TABLE 3
Percent densities for LLZO materials
formed according to Examples 1 and 2.

| | Example 2 | | Example 1 | |
|---|---|---|---|---|
| | % Density | % Density | % Density | % Density |
| | Minimum | Maximum | Minimum | Maximum |
| Dense LLZO green | 75.8% | 85.5% | 90.2% | 97.2% |
| bodies | | | | |
| (i.e., pore forming | | | | |
| agent free) | | | | |
| Porous LLZO green | 80.8% | 87.2% | 97.5% | 100.0% |
| bodies | | | | |
| (i.e., comprises pore | | | | |
| forming agent) | | | | |

The LLZO green bodies prepared according to Example 1 exhibited a higher percent density than the corresponding LLZO green bodies prepared according to Example 2. The results demonstrate that the LLZO green bodies prepared according to Example 1 possesses fewer impurities (e.g., LiHLZO) as compared to LLZO green bodies according to Example 2.

### Example 3: Sintered Bodies

The LLZO green bodies prepared according to Examples 1 and 2 were cut to a desired size and placed into a furnace with oxygen gas flow. After cutting, the LLZO green bodies prepared according to Example 1 had dimensions of 1 cm, 1 cm, and 50 μm. The LLZO green bodies prepared according to Example 2 had dimensions of 1 cm, 1 cm, and 50 μm. Oxygen gas was present during debinding to fully oxidize and volatilize any organic material present in the LLZO green bodies (e.g., binder, decomposed photoinitiator, solvent, etc.). The oven was heated from room temperature (RT) to 640 °C at a rate of 0.67 °C/minute (min). The temperature of the oven was maintained at 640 °C for about 60 mins. Then, the oven was heated to 1,100 °C at a rate of 3 °C/min. The temperature of the oven was maintained at 1,100 °C for 5 hours, and the oven was then cooled to 100 °C at a rate of 5 °C/min. The sintered bodies were removed and analyzed.

A SSE green body prepared according to Example 1 exhibited an areal shrinkage of 44% and a volumetric shrinkage of 58%. In contrast, a SSE green body prepared according to Example 2 exhibited an areal shrinkage of 60% and a volumetric shrinkage 75%. These values further demonstrate that LLZO green bodies prepared according to Example 1 possesses fewer impurities as compared to the LLZO green bodies prepared according to Example 2 with the same solids loading.

### EQUIVALENTS AND SCOPE

In the claims articles such as “a,” “an,” and “the” may mean one or more than one unless indicated to the contrary or otherwise evident from the context. Claims or descriptions that include “or” between one or more members of a group are considered satisfied if one, more than one, or all of the group members are present in, employed in, or otherwise relevant to a given product or process unless indicated to the contrary or otherwise evident from the context. The invention includes embodiments in which exactly one member of the group is present in, employed in, or otherwise relevant to a given product or process. The invention includes embodiments in which more than one, or all of the group members are present in, employed in, or otherwise relevant to a given product or process.

Furthermore, the invention encompasses all variations, combinations, and permutations in which one or more limitations, elements, clauses, and descriptive terms from one or more of the listed claims is introduced into another claim. For example, any claim that is dependent on another claim can be modified to include one or more limitations found in any other claim that is dependent on the same base claim. Where elements are presented as lists, e.g., in Markush group format, each subgroup of the elements is also disclosed, and any element(s) can be removed from the group. It should it be understood that, in general, where the invention, or aspects of the invention, is/are referred to as comprising particular elements and/or features, certain embodiments of the invention or aspects of the invention consist, or consist essentially of, such elements and/or features. For purposes of simplicity, those embodiments have not been specifically set forth in haec verba herein. It is also noted that the terms “comprising” and “containing” are intended to be open and permits the inclusion of additional elements or steps. Where ranges are given, endpoints are included. Furthermore, unless otherwise indicated or otherwise evident from the context and understanding of one of ordinary skill in the art, values that are expressed as ranges can assume any specific value or sub-range within the stated ranges in different embodiments of the invention, to the tenth of the unit of the lower limit of the range, unless the context clearly dictates otherwise.

This application refers to certain issued patents, published patent applications, journal articles, and other publications, all of which are incorporated herein by reference. If there is a conflict between any of the incorporated references and the instant specification, the specification shall control. In addition, any particular embodiment of the present invention that falls within the prior art may be explicitly excluded from any one or more of the claims. Because such embodiments are deemed to be known to one of ordinary skill in the art, they may be excluded even if the exclusion is not set forth explicitly herein. Any particular embodiment of the invention can be excluded from any claim, for any reason, whether or not related to the existence of prior art.

Those skilled in the art will recognize or be able to ascertain using no more than routine experimentation many equivalents to the specific embodiments described herein. The scope of the present embodiments described herein is not intended to be limited to the above Description, but rather is as set forth in the appended claims. Those of ordinary skill in the art will appreciate that various changes and modifications to this description may be made without departing from the spirit or scope of the present invention, as defined in the following claims.

1.-92. (canceled)

93. A green body for forming a solid-state electrolyte (SSE), wherein the green body comprises:
a LLZO material; and
a binder;
wherein the green body has a percent density of at least about 87.5%.

94. The green body of claim 93, wherein the LLZO material comprises a doped LLZO powder, wherein the doped LLZO powder comprises a dopant, and wherein the dopant comprises Be, B, Al, Fe, Zn, Ga, Ge, Na, K, Ca, Rb, Sr, Y, Ag, Ba, Bi, Pr, Nd, Pm, Sm, Gd, Tb, Dy, Ho, Er, Tm, Ce, Mg, Si, Sc, Ti, V, Cr, Mn, Co, Ni, Cu, As, Se, Nb, Mo, Tc, Ru, Rh, Pd, Cd, In, Sn, Sb, Hf, Ta, W, Ir, Pt, Au, Hg, Tl, Pb, Eu, Te, or any combination thereof.

95. The green body of claim 94, wherein the doped LLZO powder comprises a composition of Formula (I):
M1₇₋ₓD1ₐM2_{3-y}D2_{b}M3_{2-z}D3_{c}O_{12-w}D4_{d} (I)
wherein
M1 is Li;
M2 is La;
M3 is Zr;
D1 is Be, B, Al, Fe, Zn, Ga, Ge, or any combination thereof;
D2 is Na, K, Ca, Rb, Sr, Y, Ag, Ba, Bi, Pr, Nd, Pm, Sm, Gd, Tb, Dy, Ho, Er, Tm, Zn, Ce, or any combination thereof,
D3 is Mg, Si, Sc, Ti, V, Cr, Mn, Co, Ni, Cu, Ge, As, Se, Nb, Mo, Tc, Ru, Rh, Pd, Cd, In, Sn, Sb, Hf, Ta, W, Ir, Pt, Au, Hg, Ti, Pb, Ce, Eu, Te, Y, Sr, Ca, Ba, Gd, Ge, or any combination thereof; and
D4 is F, Cl, Br, I, S, Se, Te, N, P, or any combination thereof;
provided that
0≤w≤2;
−0.5<x≤3;
0≤y≤3;
0≤z≤2;
0≤a≤2;
0≤b≤3;
0≤c≤2; and
0≤d≤2;
wherein at least one of a, b, c, and d is >0.

96. The green body of claim 95, wherein the LLZO material has a D90 particle size of less than about 10 μm.

97. The green body of claim 96, wherein the binder is cured by exposure to ultraviolet (UV) radiation.

98. The green body of claim 97, wherein the binder comprises a cross-linkable polymer material.

99. The green body of claim 98, wherein the green body has a thickness of from about 500 nm to about 1000 μm.

100. The green body of claim 99, wherein the LLZO material is further defined as a first LLZO material, wherein the binder is further defined as a first binder, and wherein the green body further comprises:
a first layer comprising the first LLZO material and the first binder; and
a second layer at least partially disposed on the first layer and comprising a second LLZO material and a second binder.

101. The green body of claim 100, wherein the second layer further comprises a pore forming agent.

102. The green body of claim 101, wherein the first layer is substantially free of a pore forming agent.

103. The green body of claim 102, wherein the first layer has a thickness of from about 500 nm to about 1000 μm.

104. The green body of claim 103, wherein the second layer has a thickness of from about 500 nm to about 1000 μm.

105. The green body of claim 104, wherein the green body is substantially free of any LiHZO impurities.

106. A sintered SSE material comprising:
(i) less than about 10 wt % of LiHLZO by weight of the sintered SSE material; and
(ii) greater than 90 wt % by weight of the sintered SSE material of a doped LLZO material of Formula (V)
Li₇₋ₓBa La_{3-y}C_{b}Zr_{2-z}D_{c}O₁₂ (V),
wherein:
B is Al or Ga;
C is Ca, Sr, Ba, or Mg;
D is Ta, Nb, W, Mo, or Ti;
−0.5<x≤1;
0≤a≤0.24;
0≤y≤0.5;
0≤b≤0.5;
0≤z 1; and
0≤c K 1;
where x, a, y, b, z, and c are independent of each other.

107. The sintered SSE material of claim 106, wherein
0.2<x≤0.8;
0≤a≤0.15;
0≤y≤0.3;
0≤b≤0.3;
0≤z 1; and
0≤c1.

108. The sintered SSE material of claim 107, wherein x is 0.15 to 0.7.

109. The sintered SSE material of claim 108, wherein B is Al, and a is 0.05 to 0.15.

110. The sintered SSE material of claim 108, wherein B is Ga, and a is 0.05 to 0.8.

111. The sintered SSE material of claim 108, wherein y is 0.05 to 0.30.

112. The sintered SSE material of claim 111, wherein C is Ca, and b is 0.05 to 0.25.

113. The sintered SSE material of claim 111, wherein C is Ba, and b is 0.05 to 0.10.

114. The sintered SSE material of claim 111, wherein C is Sr, and b is 0.25 to 0.30.

115. The sintered SSE material of claim 111, wherein C is Mg, and b is 0.22 to 0.28.

116. The sintered SSE material of claim 111, wherein z is 0.50 to 1.

117. The sintered SSE material of claim 116, wherein D is Ta, and c is 0.4 to 0.6.

118. The sintered SSE material of claim 116, wherein D is Nb, and c is 0.2 to 0.4.

119. The sintered SSE material of claim 116, wherein D is Ti, and c is 0.8 to 1.0.

120. The sintered SSE material of claim 116, wherein D is W, and c is 0.2 to 0.4.

121. The sintered SSE material of claim 107, comprising a dense layer and a porous layer, wherein the dense layer has a percent density at least about 1.5% greater than the percent density of the porous layer.

122. A green body for forming a solid-state electrolyte (SSE), wherein the green body comprises:
a LLZO material wherein the LLZO material comprises less than about 10 wt % of LiHLZO by weight of the LLZO material; and
a binder,
wherein the green body comprises from about 30% to about 60% of binder by volume of the green body.

123. The green body of claim 122, wherein the LLZO material comprises a composition of Formula (V):
Li₇₋ₓBa La_{3-y}C_{b}Zr_{2-z}D_{c}O₁₂ (V),
wherein:
B is Al or Ga;
C is Ca, Sr, Ba, or Mg;
D is Ta, Nb, W, Mo, or Ti;
−0.5<x≤1;
0≤a≤0.24;
0≤y≤0.5;
0≤b≤0.5;
0≤z≤1; and
0≤c≤1; where x, a, y, b, z, and c are independent of each other.

124. The green body of claim 123, wherein x is 0.15 to 0.7.

125. The green body of claim 124, wherein B is Al, and a is 0.05 to 0.15.

126. The green body of claim 124, wherein B is Ga, and a is 0.05 to 0.8.

127. The green body of claim 124, wherein y is 0.05 to 0.30.

128. The green body of claim 127, wherein C is Ca, and b is 0.05 to 0.25.

129. The green body of claim 127, wherein C is Ba, and b is 0.05 to 0.10.

130. The green body of claim 127, wherein C is Sr, and b is 0.25 to 0.30.

131. The green body of claim 127, wherein C is Mg, and b is 0.22 to 0.28.

132. The green body of claim 127, wherein z is 0.50 to 1.

133. The green body of claim 132, wherein D is Ta, and c is 0.4 to 0.6.

134. The green body of claim 134, wherein D is Nb, and c is 0.2 to 0.4.

135. The green body of claim 132, wherein D is Ti, and c is 0.8 to 1.0.

136. The green body of claim 132, wherein D is W, and c is 0.2 to 0.4.

137. The green body of claim 123, wherein the LLZO material is calcined.

138. The green body of claim 123, wherein the binder comprises a polysiloxane, polyurethane, a polythioester, a polyacrylate, a vinyl polymer, a polyisoprene, or any combination thereof.

139. The green body of claim 138, further comprising an initiator, wherein the initiator is a photoinitiator comprising 2,2-dimethoxy-1,2-diphenylethan-1-one, maleimides, 2-hydroxy-2-methyl-1-phenylpropanone, 1-hydroxy-cyclohexylphenylketone, oligo(2-hydroxy-2-methyl-1-[4-(1-methylvinyl)phenyl]propanone, 2-hydroxy-2-methyl-1-phenylpropan-1-one, benzophenone, 4-Phenylbenzophenone, bis[4-(dimethylamino)phenyl]methanone, methylbenzophenone, 4,4′-Bis(diethyl amino)benzophenone, 4-(2-hydroxyethoxy)phenyl-(2-hydroxy-2-methylpropyl)ketone, hydroxyacetophenone, isopropyl thioxanthone, 2,4,5-trimethylbenzoly-diphenyl phosphine oxides, bis(2,6-dimethyloxybenzoyl) 2,4,4-trimethylpentyl)phosphine oxide, bis(2,4,6-trimethylbenzoyl)-phenylphosphineoxide, benzyldimethyl ketal, camphorquinone, 2-hydroxy-2-methyl-1-(4-t-butyl)phenylpropan-1-none, bis(2,4,6-trimethylbenzoyl), 2-benzyl-2-N,N-dimethylamino-1-(4-morpholinophenyl)-1 butanone, 2-mercaptobenzoxazole, 2-methyl-1-[4-(methylthiophenyl)-2-morpholinopropanone, 2-ethylhexyl-(4-N,N-dimethyl amino)benzoate, ethyl-4-(dimethylamino)benzoate, or any combination thereof.

140. The green body of claim 141, further comprising a dispersant, wherein the dispersant comprises a fish oil, a fatty acid ester, sulfonated fatty acid, or any combination thereof.

141. The green body of claim 140, wherein the LLZO material comprises less than about 5 wt % of LiHLZO by weight of the LLZO material.

142. The green body of claim 141, further comprising a dense layer and a porous layer, wherein the dense layer has a percent density that is at least 1% greater than the percent density of the porous layer.

143. The green body of claim 142, wherein the porous layer is disposed on at least a portion of the dense layer.

144. A method of forming a green body for a solid-state electrolyte, the method comprising:
(a-1) reacting a precursor mixture to form a LLZO material, wherein the precursor mixture comprises
(i) a lithium-containing compound,
(ii) a lanthanum-containing compound, and
(iii) a zirconium-containing compound;
(b-1) mixing the LLZO material with a binder composition to form a curable SSE mixture;
(c-1) forming a curable green body from the curable SSE mixture; and
(d-1) curing the curable green body to form the SSE green body.

145. The method of claim 144, wherein the precursor mixture further comprises a dopant, and wherein the dopant comprises Be, B, Al, Fe, Zn, Ga, Ge, Na, K, Ca, Rb, Sr, Y, Ag, Ba, Bi, Pr, Nd, Pm, Sm, Gd, Tb, Dy, Ho, Er, Tm, Ce, Mg, Si, Sc, Ti, V, Cr, Mn, Co, Ni, Cu, As, Se, Nb, Mo, Tc, Ru, Rh, Pd, Cd, In, Sn, Sb, Hf, Ta, W, Ir, Pt, Au, Hg, Tl, Pb, Eu, Te, or any combination thereof.

146. The method of claim 145, wherein the lithium-containing compound comprises Li₂O, LiOH, LiOH·H₂O, LiCl, Li₂CO₃, LiNO₃, or any combination thereof.

147. The method of claim 146, wherein the lanthanum-containing compound comprises La₂O₃, La(OH)₃, LaCl₃, La₂(CO₃)₃, La(NO₃)₃, or any combination thereof.

148. The method of claim 147, wherein the zirconium-containing compound comprises ZrO₂, Zr(OH)₄, ZrCl₄, Zr(OH)₂CO₃·ZrO₂, Zr(NO₃)₄, or any combination thereof.

149. The method of claim 148, wherein the reacting step (a-1) further comprises reacting the precursor mixture by calcination to form the LLZO material.

150. The method of claim 149, wherein the calcination is performed at a temperature of from about 700 °C to about 1,100 °C.

151. The method of claim 150, further comprising
(e-1) dry milling the LLZO material to form a milled LLZO material.

152. The method of claim 151, wherein the dry milling step (e-1) is performed prior to the mixing step (b-1).

153. The method of claim 152, wherein the dry milling step (e-1) further comprises
(e1-1) mixing the LLZO material with a milling additive; and
(e2-1) dry milling the LLZO material to form a milled LLZO material.

154. The method of claim 153, wherein the milled LLZO material has a D90 particle size of less than about 10 μm.

155. The method of claim 154, wherein the binder composition comprises a binder and an initiator.

156. The method of claim 155, wherein the binder comprises a polysiloxane, polyurethane, a polythioester, a polyacrylate, a vinyl polymer, a polyisoprene, or any combination thereof.

157. The method of claim 156, wherein the initiator comprises a photoinitiator, and wherein the photoinitiator comprises 2,2-dimethoxy-1,2-diphenylethan-1-one, maleimides, 2-hydroxy-2-methyl-1-phenylpropanone, 1-hydroxy-cyclohexylphenylketone, oligo(2-hydroxy-2-methyl-1-[4-(1-methylvinyl)phenyl]propanone, 2-hydroxy-2-methyl-1-phenylpropan-1-one, benzophenone, 4-Phenylbenzophenone, bis[4-(dimethylamino)phenyl]methanone, methylbenzophenone, 4,4′-Bis(diethyl amino)benzophenone, 4-(2-hydroxyethoxy)phenyl-(2-hydroxy-2-methylpropyl)ketone, hydroxyacetophenone, isopropyl thioxanthone, 2,4,5-trimethylbenzoly-diphenyl phosphine oxides, bis(2,6-dimethyloxybenzoyl) 2,4,4-trimethylpentyl)phosphine oxide, bis(2,4,6-trimethylbenzoyl)-phenylphosphineoxide, benzyldimethyl ketal, camphorquinone, 2-hydroxy-2-methyl-1-(4-t-butyl)phenylpropan-1-none, bis(2,4,6-trimethylbenzoyl), 2-benzyl-2-N,N-dimethylamino-1-(4-morpholinophenyl)-1 butanone, 2-mercaptobenzoxazole, 2-methyl-1-[4-(methylthiophenyl)-2-morpholinopropanone, 2-ethylhexyl-(4-N,N-dimethyl amino)benzoate, ethyl-4-(dimethylamino)benzoate, or any combination thereof.

158. The method of claim 157, wherein the forming step (c-1) further comprises casting a layer of curable SSE mixture onto a substrate, wherein the dense layer has a thickness of from about 750 nm to about 1000 μm.

159. The method of claim 158, wherein the curing step (d-1) further comprises curing the curable green body with ultraviolet (UV) radiation, heat, electron beam (e-beam) radiation, or any combination thereof to form the SSE green body.
